(19) United States
(12) Patent Application Publication
(10) Pub. No.: US 2019/0332728 A1
(43) Pub. Date: Oct. 31, 2019

(54) Method for Modeling Interfaces

(71) Applicants: Isaac Perez-Raya, Rochester, NY (US); Satish Kandlikar, Rochester, NY (US)

(72) Inventors: Isaac Perez-Raya, Rochester, NY (US); Satish Kandlikar, Rochester, NY (US)

(73) Assignee: Rochester Institute of Technology, Rochester, NY (US)

(21) Appl. No.: 15/964,725

(22) Filed: Apr. 27, 2018

(51) Int. Cl. G06F 17/50

(52) U.S. Cl. CPC G06F 17/5009; G06F 2217/16

(57) ABSTRACT

Simulations of interfacial phenomena are useful to understand and predict the phase-change processes that occur around the interface at various operating conditions. A method is described that simplifies the simulation of interfaces and the transport processes occurring across the interfaces. The method accurately determines the fixed ϕ value at the computational cells that have an interface (mixture cells), which is needed for a proper representation of the interface. Moreover, the method accurately determines the gradient of ϕ at the interface, which is needed for a proper estimation of the mass transfer at the interface.

### CROSS REFERENCE

This application claims the benefit of the filing date of U.S. Provisional Patent Application Nos. 62/490,957 filed Apr. 27, 2017 and 62/510,981 filed May 25, 2017, which are hereby incorporated by reference in their entirety.

This invention was made with government support under grant number CBET-1335927 awarded by National Science Foundation. The government has certain rights in this invention.

### FIELD

The present invention relates to a method for modeling interfaces, and in particular to a method for determining the fixed value of the variable ϕ and the interfacial mass transport.

### BACKGROUND

Complex simulations consist on finding the behavior of a variable ϕ on a domain that contains multiple fluids or phases. A simulation of this kind should define cells with properties that are defined based on the location of the fluids on the computational domain at a particular time. Also special attention should be paid on the characterization of the mixture cells, which are cells that are divided by an interface (the interface is the boundary between two phases). The other difficulty appears when there is mass transfer at the interface, this is because in some cases (evaporation, condensation, melting, species transport) the mass transfer depends on the gradient of the variable ϕ at the interface.

Various methods have been proposed to define the edge to fluid in a simulation. One effective method is to fix the value of ϕ at the computational cells that have an interface or edge (mixture cells). The fixed value is determined based on the conditions at the interface and the behavior of the variable ϕ around the interface. The gradient of the variable ϕ determines the transport through the interface; the estimation of the gradient of the variable ϕ at the interface is not trivial. This is because the gradient is calculated in a direction normal to the interface and this direction might not intersect the location at which ϕ is determined in the simulation (usually this location corresponds to the center of the computational cells).

The technical literature distinguishes various methods to compute the gradient of the variable ϕ which is needed for the computation of the transport of species or mass across the interface, see FIG. 1. Such methods are generally applied for the simulation of evaporation and condensation or reaction of species in droplets or bubbles. In these particular cases, the mass or species transport is governed by the temperature gradient at the interface. Therefore, these simulations consider the temperature as the variable ϕ.

FIG. 2 shows different approaches to find the temperature gradients used for the mass transfer computation. FIG. 2A shows the method proposed by Ling, K., Li, Z.-Y., and Tao, W.-Q., 2014, “A Direct Numerical Simulation for Nucleate Boiling by the VOSET Method,” Numer. Heat Transf. Part-Appl., 65(10), pp. 949-971. The method uses the temperature of two neighboring cells and the temperature of the mixture cell. The temperature gradient is given by ∇T=(T_{i,j}−Tₛₐₜ)/d, where T_{i,j} is the temperature of the mixture cell, and d is the distance from the mixture cell center to the interface. To find T_{i,j} the authors assumed that the temperature gradient at the interface is similar to the temperature gradient at the mixture cell center given by ∇T=(T_{i+1,j}−T_{i,j})/Δx·nₓ+(T_{i,j-1}−T_{i,j})/Δy·n_{y}. The method requires the identification of three cells and errors may arise when the interface is far from the mixture cell center.

Udaykumar, H., and Shyy, W., 1995, “Simulation of Interfacial Instabilities During Solidification .1. Conduction and Capillarity Effects,” Int. J. Heat Mass Transf, 38(11), pp. 2057-2073 used a biquadratic polynomial function of the form T(x, y)=ax²+bxy+cy²+dx+ey+f to define the temperature field near the interface, as shown in FIG. 2B. The method injects a probe of length 1.4Δx, which is normal to the interface. The polynomial function finds the temperature at the tip of the probe xref, yref. The method estimates the temperature gradient with ∇T=(T_{ref}−Tₛₐₜ)/d, where d is the length of the probe. The main difficulty is the identification of six cells to determine the coefficients of the polynomial.

The method proposed by Sato, Y., and Ničeno, B., 2013, “A Sharp-Interface Phase Change Model for a Mass-Conservative Interface Tracking Method,” J. Comput. Phys., 249, pp. 127-161 finds the temperature gradient at the neighboring cell center, as shown in FIG. 2C. The method estimates the gradient with the distance from the interface to the neighboring cell centers along the x and y coordinates. The temperature gradient is given by ∇T=T_{x,(i,j)}nₓ+T_{y,(i,j)}n_{y}. The temperature gradients in the x and y direction use a second order approximation given by Tₓ=(−hₓ²Tₛₐₜ+(hₓ²−Δx²)T_{i,j}+Δx²T_{i+1,j})/(Δxhₓ(Δx+hₓ)) (a similar approximation was used for T_{y}). When the interface does not intersect the line that connects the cell centers of the mixture and neighboring cells, the temperature gradient uses an interpolated mixture cell temperature. The method requires various neighboring cells around the interface and interpolation functions to find the temperature of the mixture cell. Also, errors might be introduced by estimating the mass flux with the temperature gradients at the neighboring cell center rather than at the interface.

The methods presented above require the identification of multiple cells around the interface. For instance, the method of Udaykumar and Shyy requires the identification of six cells around the interface to define the coefficients of the polynomial function, whereas the other methods require the identification of three cells around the interface. The requirement of multiple cells around the interface complicates the application of these methods since identification algorithms should be designed to locate these cells. Another difficulty is that the methods rely on the temperature of mixture cells. Therefore the methods require special algorithms to define the temperature of the mixture cells.

### SUMMARY

In accordance with one aspect of the present invention, there is provided a method for modeling interfaces including:

determining a fixed value of a variable ϕ at mixture cells for a representation of an interface; and

determining the mass transfer through the interface with the gradient of ϕ at the interface, wherein the gradient is computed on a phase that is driving the mass transfer, wherein fixing the value of the mixture cells, the gradient is computed on the phase driving the mass transfer, by evaluating the gradient of the variable ϕ by performing an algorithm that identifies the center of cell in the phase that is closest to the interface in the normal direction, the algorithm injecting three proves in a direction perpendicular to the interface, and the fixed value of the variable ϕ and the interfacial mass transport are found with the information of the length of the probes and the values of the variable ϕ at the extremes of the probes, wherein mathematical expressions are derived based on the gradients of the variable ϕ at two different locations at the interface, such that a representation of the conditions at the interface in a multiphase simulation and computation of the mass transfer at the interface are achieved.

In accordance with another aspect of the present disclosure, there is provided a one-cell method for evaluating the temperature gradient at the interface, including:

1) identifying a mixture cell for which a fixed ϕ value or the mass transfer is to be determined;

2) injecting a probe-1, wherein the origin is the mixture cell center, the orientation is normal to the interface, and the length is such that the tip intersects the interface such that the point intersects the probe-1 with the interface at a point a;

3) injecting a probe-2, wherein the origin is the point a, the orientation is normal to the interface, and the length is d₂;

4) exploring a region around the tip of the probe-2 to find the center of an I-cell that is nearest to the interface in the normal direction;

5) injecting a probe-3, wherein the origin is the cell center of the I-cell, the orientation is normal to the interface, and the length is determined by the following steps 6) and 7);

6) creating a vector \vec{r_{I}} connecting the center of the I-cell with the point a at the interface; and

7) determining the length of the probe-3 by the projection of the vector \vec{r_{I}} on the normal vector \hat{n}, and determining the intersection point b between the probe-3 and the interface.

In accordance with another aspect of the present disclosure, there is provided a method including:
injecting three probes that are perpendicular to the interface, wherein probe-1 supports the injection of probe-2, probe-1 and probe-2 support the construction of probe-3 and probe-3 is normal to the interface, and has a length such that the tip of the probe intersects a cell center on a phase;
injecting probe-1 based on the identification of the computational cell that has an interface, wherein the origin of probe-1 is the mixture cell center, the orientation is normal to the interface, and the tip of the probe is the intersection of the probe with the interface, wherein the point that intersects the probe with the interface can be identified as point a, the length of the probe-1 is given by d₁, and the length of the probe is determined based on the origin and the tip of probe-1;
injecting probe-2 based on the tip of the probe-1 point a, wherein the origin of probe-2 is point a, the orientation is normal to the interface, and the length is d₂;
using probe-2 to identify the center of computational cell in a phase that is closest to the interface along the normal direction, wherein the nearest cell can be identified as I-cell;
exploring a region that uses the tip of probe-2 as a reference point to find the center of the I-cell that is nearest to the interface along the normal direction, wherein the center of the explored region corresponds to the location of the tip of probe-2, wherein the dimensions of the explored region are Δx in the x-direction, Δy in the y-direction, and Δz in the z-direction, where x, y, and z represent the coordinates of a Cartesian system and Δx, Δy, and Δz are the lengths of the computational cells in the x, y, and z, directions, respectively;
using the I-cell to inject the probe-3, wherein the origin of the probe-3 is the center of the I-cell, the orientation is normal to the interface, and the length is determined by the projection or dot-product of the vector \vec{r_{I}} on the unit vector that is normal to the interface \hat{n}, wherein (d₃=\vec{r_{I}}·\hat{n}). \vec{r_{I}} is a vector that connects the center of the I-cell with the point a at the interface;
using the lengths of probe-1 “d₁” and probe “d₃” and the values of the variable ϕ at the extremes of the probes to determine the value ϕ_{M} of the computational cells that have an interface;
determining the fixed value ϕ_{M} by adding the product of the length of the probe-1 “d₁” with the gradient of the variable ϕ at point a to the value of the variable ϕ at the interface, wherein ϕ_{M}=ϕᵢₙ+d₁(ϕ_{I}−ϕᵢₙ)/d₃. ϕᵢₙ is the value of the variable ϕ at the interface and ϕ_{I} is the value of the variable ϕ inside the computational cell-I;
using the lengths of probe-1 “d₁” and probe “d₃” and the values of the variable ϕ at the extremes of the probes to determine the transport of mass or species or any other transport across the interface;
determining the transport of mass or species m″ by the product of a parameter α and the gradient of the variable ϕ at point “a”, m″=α(ϕ_{I}−ϕᵢₙ)/d₃, where α is constant or a variable parameter that depends on the properties of the fluids or phases in the simulation;
estimating the length of the probe-2 based on the dimensions of the mixture-cell, wherein the length of probe-2 d₂ is such that the tip of probe-2 lies outside of the mixture cell; and
identifying the center of the I-cell based on the tip of probe-2 and an explored region, wherein the length of the explored region is given the dimensions of the computational cells (Δx, Δy, and Δz) or by any other parameters.

These and other aspects of the present disclosure will become apparent upon a review of the following detailed description and the claims appended thereto.

### BRIEF DESCRIPTION OF THE DRAWINGS

FIG. 1 illustrates a classification of cells in a computational domain;

FIG. 2A illustrates according to Ling et al., 2B according to Udaykumar and Shyy and 2C according to Sato and Niceno, methods to compute the temperature gradient;

FIGS. 3A illustrates Steps 1) to 4) and 3B Steps 5) to 7) of the one-cell method to evaluate the temperature gradient at the interface in accordance with the present invention;

FIG. 4 shows diagrams for the estimation of ∇T of three different interfaces according to known methods and a method in accordance with the present invention;

FIG. 5 shows computational domain in the simulation of spherical bubble growth with mass transfer at the interface;

FIG. 6A shows simulation with the present method to fix the temperature of the mixture cells and 6B shows simulation with average properties of the effect of the mixture cell characterization on the temperature field around the interface of a spherical bubble;

FIG. 7 is a plot of the accuracy of the present method for the estimation of the interface cell temperature;

FIG. 8 is a plot of a comparison of the bubble radius in the simulation against theoretical data;

FIGS. 9A shows t=0.08 ms and 9B shows t=0.125 ms of temperature distribution in non-adiabatic bubble growth of grid cells size Δs=0.8 μm;

FIG. 10 illustrates identification of I-cell with loops around mixture and neighboring cells A, B, C, and D (cells with dots) and cells 1, 2, 3, and 4 that surround the neighboring cells;

FIG. 11 is a plot of accuracy on the estimation of interfacial ∇T with the present method having a bubble radius 0.1 mm and grid cell size 0.6 μm;

FIG. 12 is a plot of accuracy of the present method with various grid cell sizes and bubble of 0.1 mm bubble radius;

FIG. 13A is a plot of percentage of relative error and 13B is a plot of magnitude of mixture cell temperature of accuracy on the estimation of the mixture cell temperature along the interface;

FIG. 14 is a schematic flow chart of ANSYS-Fluent procedures and customization;

FIG. 15A illustrates planar interface evaporation—Stefan problem and 15B illustrates spherical bubble growth of fundamental problems of phase change;

FIG. 16 is a plot of comparison simulation versus theory of the interface displacement in evaporation with a planar interface;

FIG. 17 is a plot of accuracy of the numerical simulation on the prediction of the temperature field in the vapor and liquid phases at 0.2 s of planar interface evaporation;

FIG. 18 is a plot of accuracy of the estimated normal vector at the interface in the simulation of adiabatic bubble growth;

FIG. 19 is a plot of comparison of the numerical and liquid velocities near the interface of grid cell size Δs=1 μm;

FIG. 20 is a plot of fluid velocity during bubble growth of grid cell size Δs=1 μm, skipping few numerical data points for clarity purposes;

FIG. 21 is a plot of comparison theory versus simulation of adiabatic bubble growth with a constant mass flux;

FIG. 22A shows grid cell size Δs=10 μm and 22B shows grid cell size Δs=5 μm of comparison vapor volume-fractions at 0.5 ms in axisymmetric bubble growth;

FIG. 23A shows grid cell size Δs=10 μm and 22B shows grid cell size Δs=5 μm of comparison fluid velocity vectors in adiabatic bubble growth;

FIG. 24 is a plot of accuracy of the estimation of the temperature gradient at the interface in the simulation;

FIG. 25 is a plot of accuracy of the present method for the estimation of the interface cell temperature;

FIG. 26 is a plot of prediction of the bubble growth rate of non-adiabatic bubble growth with temperature gradients at the interface;

FIGS. 27A shows t=0.08 ms and 27B shows t=0.125 ms of field of vapor volume-fraction in non-adiabatic bubble growth of grid cell size 0.8 μm;

FIGS. 28A shows t=0.08 ms and 28B shows t=0.125 ms of velocity vectors in non-adiabatic bubble growth wherein axis dimension is in meters and grid cell size is 0.8 μm, the red line represents the interface location; and

FIGS. 29A shows t=0.08 ms and 29B shows t=0.125 ms of temperature distribution in non-adiabatic bubble growth with grid cell size Δs=0.8 μm.

### DETAILED DESCRIPTION

The present invention provides a method to include the interface or edge between multiple fluids and to compute the transport of species or mass or any other variable across the interface in a computer simulation. The method includes the interface in the simulation by adjusting or fixing the value of the variable ϕ of the computational cells that have an interface (mixture cells). The method provides a direct estimation of the value of the variable ϕ based on the interfacial gradient of ϕ and the location of the interface. The method estimates the transport of mass or any other variable across the interface based on the gradient of the variable ϕ at the interface.

The present method determines the gradient of the variable ϕ (needed to find the fixed value of the variable ϕ and the interfacial transport) by identifying the center of computational cell that is near to the interface along the normal direction. The method injects three probes in a direction perpendicular to the interface. The fixed value of the variable ϕ and the interfacial mass transport are found with the information of the length of the probes and the values of the variable ϕ at the extremes of the probes. The method can be implemented in numerical simulations to model complex interfaces. It can be applied to boiling, condensation, solidification, phase transitions, and the like. The model can be applied with any interface tracking algorithm. The results clearly show the benefits in terms of simplicity and high accuracy.

In computer simulations, the region of analysis is known as computational domain. The objective of a computer simulation is to determine the behavior of a variable ϕ in the computational domain. The variable ϕ could be any property such as temperature, velocity, momentum, magnetic field, species concentration, etc. To perform this task, the computational domain is divided into multiple subregions (also known as computational cells). The computational cells are used to form a system of equations, which solution gives the values the variable ϕ at each cell center. In the simulation, each computational cell is characterized with properties of the medium (electrical conductivity, thermal conductivity, density, viscosity, specific heat, etc.).

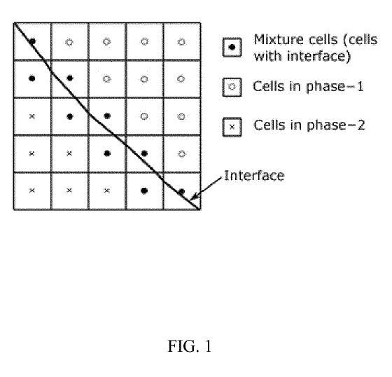

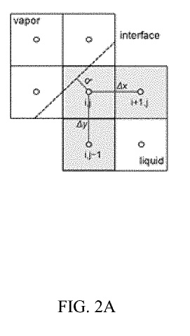

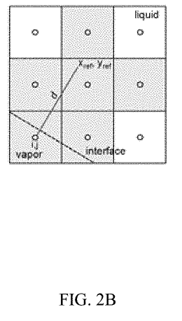

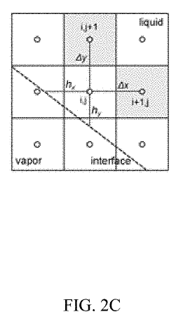

In multiphase simulations, two or more phases interact inside a computational domain, see FIG. 1. These phases could be solid, liquid, or vapor. The division between two phases is known as “interface”. In the simulation of multiphase flows, the interface passes through computational cells. The computational cells that are divided by an interface are known as mixture cells.

A difficulty in multiphase simulations is the characterization of the interface. An accurate approach to characterize the mixture cells in multiphase simulations is to fix ϕ at the mixture cells. Fixing ϕ at the mixture cell means that a value of the variable ϕ is imposed at the mixture cells during the simulation. The main advantage of fixing ϕ at the mixture cells is that errors that appear with the use of average properties (density, viscosity, thermal conductivity, etc.) on these cells are eliminated. However, one of the challenges is a proper estimation of the fixed ϕ value at the mixture cells.

Another challenge of simulations with multiphase flows appears when there is transport of species or mass across the interface. Mass transfer at the interface occurs in evaporation, solidification, and melting. In these phase-change processes, the mass or species transfer depends on the gradient of ϕ at the interface, where ϕ is temperature. Eq. (1) provides the rate of mass transfer at the interface.

$${m}^{″} = \frac{{k ∇ φ \vert}_{in}}{{h}_{fg}} \qquad ( 1 )$$

where k is the thermal conductivity of phase 1 or phase 2, depending on the phase in which the temperature gradient is calculated, and h_{fg} is the latent heat. In a computer simulation, the gradient of ϕ at the interface is difficult to determine because its direction (perpendicular to the interface) rarely intersects a cell center (the location at which ϕ is known in the simulation).

This invention presents a method for modeling interfaces and transport processes occurring across the interfaces. The method accurately determines the fixed ϕ value at the mixture cells, which is needed for a proper representation of the interface. Moreover, the method accurately determines the gradient of ϕ at the interface, which is important for a proper estimation of the mass transfer at the interface.

The present method finds the fixed ϕ value at the mixture cell and the mass transfer through the interface with the gradient of ϕ at the interface. The gradient is computed on the phase that is driving the mass transfer. Also, in the case of fixing the value of the mixture cells, the gradient is computed on the phase that is under consideration. For example, during evaporation resulting from heat transfer in the liquid phases, it is desired to determine the gradient at the interface on the liquid side. While finding the variable ϕ on the liquid phase, the fixed value of the mixture cells should consider gradients of ϕ on the liquid phase. Similarly, while finding the variable ϕ on the vapor phase, the fixed value of the mixture cells should consider gradients of ϕ on the vapor phase.

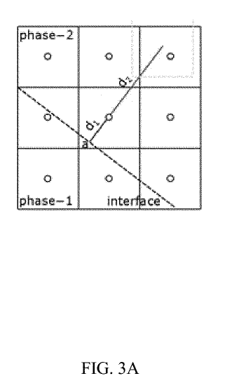

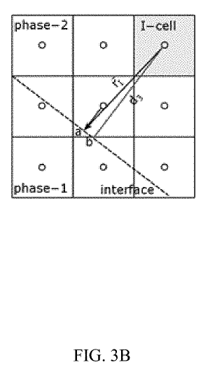

FIGS. 3A and 3B illustrate the procedures to determine the gradient of ϕ at the interface. The method consists on injecting three probes that are perpendicular (or normal) to the interface. Probe-1 supports the injection of probe-2. Probe-1 and probe-2 support the construction of probe-3. The importance of probe-3 is its orientation and its length; this probe is normal to the interface, and has a length such that the tip of the probe intersects a cell center on a phase. After the injection of the three probes, mathematical expressions find the fixed ϕ value at the mixture cell and the mass transfer through the interface.

The objective of probe-1 is to locate the closest point on the interface from the mixture cell center, the objective of probe-2 is to identify the cell that is closest to the interface in the normal direction (the I-cell), and the objective of probe-3 is to determine the gradient of ϕ at the interface. Although the method described gives a specific technique to identify the cell that is closest to the interface in the normal direction (the I-cell), any other technique can be employed to identify this cell, such as using different probes lengths, information derived from the surrounding cells such as void fraction, volume-of-fluid values, or level-set values.

It is desirable to identify the I-cell for improved accuracy. However, considering the ease of identifying such cells, it may be useful to accept cells that are one or more cells around the I-cell in the desired phase where the gradients of ϕ are being determined. Since the size of the cell may be small, the overall error in estimating the mass transfer or the fixed ϕ at the mixture cell may not be significant. These factors need to be considered while selecting a scheme for identifying the I-cell or the cells around this cell.

FIG. 3A steps 1) to 4) and 3B steps 5) to 7) show the one-cell method to evaluate the temperature gradient at the interface. The steps to inject the probes are described in the following lines:
Probe-1 1) Identify a mixture cell for which the fixed ϕ value or the mass transfer should be determined.
   2) Inject probe-1. The origin of this probe is the mixture cell center, the orientation is normal to the interface, and the length is such that the tip intersects the interface. The point that intersects the probe with the interface is called “point a”.
Probe-2 3) Inject probe-2. The origin of this probe is “point a”, the orientation is normal to the interface, and the length is d₂.
   4) Explore a region around the tip of probe-2 to find the center of the cell that is nearest to the interface in the normal direction. The name of the nearest cell is “I-cell”.
Probe-3 5) Inject probe-3. The origin of this probe is the cell center of the I-cell, the orientation is normal to the interface, and the length is determined with the following steps.
   6) Create a vector \vec{r_{I}} connecting the center of the I-cell with the “point a” at the interface.
   7) Determine the length of probe-3 by the projection of the vector \vec{r_{I}} on the normal vector \hat{n}. The name of the intersection between probe-3 and the interface is “point b”.

In the procedure for the probes injection, the length of probe-2 d₂ in step 3) is such that the tip of probe-2 lies outside of the mixture cell. A proper length d₂ could be determined based on the size of the mixture cell. The tip of the probe lies outside the mixture cell if the length is larger than the maximum distance between two points on the periphery of the mixture cell. This distance is given by \sqrt{Δx²/Δy²}, where Δx and Δy are the length of the cell in the x and y directions, respectively. Therefore, d₂ could be greater than \sqrt{Δx²+Δy²}. For the square grids of size Δx a probe-2 length of Δx\sqrt{2} or longer is preferred. Other preferred lengths may lie in the range 0.5 to 3 times the length Δx\sqrt{2}. An additional conditional may be incorporated to check that the selected cell that is used to estimate the gradient of ϕ is indeed a cell in the phase of analysis and not the mixture cell. In case it is determined that the tip of probe-2 ends in a mixture cell, a corrective action may be implemented. This corrective action may include, but not limited to, extending the length of the probe-2. Similar approach may be applied for rectangular grids with different Δx and Δy, or cells with any other shapes including but not limited to triangles, tetrahedron, prism, pyramid, or arbitrary polyhedrons.

Another important factor is the region explored to find the nearest cell center in step 3). This step should ensure that only the nearest cell center is inside the perimeter of exploration. To perform this task, the center of the explored region should be the tip of the probe-2, and the length of the explored region could be Δx in the x-direction and Δy in the y-direction.

In step 7), Eq. (2) determines the length of probe-3:

d₃=\vec{r_{I}}·\hat{n} (2)

where \hat{n} is a unit vector that is normal to the interface.

It is important to emphasize that the method is applicable to 1-dimensional, 2-dimensional, or 3-dimensional analyses in Cartesian, cylindrical, spherical, or other kind of coordinates. In 3-dimensional analyses, the length of probe-2 can be determined using the three sides of the cell and using a similar logic as in the case of 2-dimensional analysis.

After performing the proper injection of the three probes, the values of ϕ at the extremes of the probes and the length of the probes determine the gradients of ϕ at the interface. These gradients form the basis of the proposed expressions to estimate the fixed ϕ value at the mixture cell and the mass transfer through the interface.

Particularly, the method requires the gradients at points “a” and “b” (see FIG. 3). The gradient of ϕ at points “a” and “b” are given by the difference of the ϕ values at the tip and origin of the probe divided by the length of the probe. Eq. (3) gives the gradient of ϕ at point-a, whereas Eq. (4) gives the gradient of ϕ at point-b.

$${{∇ φ \vert}_{a} = \frac{{φ}_{M} - {φ}_{in}}{{d}_{1}} \\ ∇ φ \vert}_{b} = \frac{{φ}_{I} - {φ}_{in}}{{d}_{3}} \qquad ( 3 )$$

where ϕϕ is the value of ϕ at the center of the mixture cell, which lies at the tip of the probe 1. ϕ_{I} is the value of ϕ at the center of the I-cell, which lies at the tip of the probe 2. d₁ and d₃ are the length of the probes 1 and 3, respectively. ϕᵢₙ is the value of ϕ at the interface, which depends on the properties of the interface.

It is important to emphasize that the estimation of the gradients assumed a first order backward approximation. However, the method can be extended to develop a second or higher order approximation. This can be done by extending the length of the probe-2 to explore other regions allowing the identification of other cells along the normal direction.

As it was previously stated, the mass transfer through the interface is proportional to the gradient of ϕ at the interface, see Eq. (1). The main difficulty in Eq. (1) was the estimation of the gradient of ϕ at the interface, where ϕ is temperature. The present method determines the temperature gradient at points “a” and “b” at the interface. Under this scenario, the mass transfer can be determined as:

$${m}^{″} = \frac{{k ∇ φ \vert}_{b}}{{h}_{fg}} = \frac{k}{{h}_{fg}} \frac{{φ}_{I} - {φ}_{in}}{{d}_{3}} \qquad ( 5 )$$

In Eq. (5), probe-3 determines the temperature gradient. For the estimation of the mass transfer, probe-3 is more convenient than probe-1 because the tip of probe-3 lies at a cell of a phase rather than at a mixture cell.

The aspect that is missing is the estimation of the fixed φ value at the mixture cell. The information on probe-1 and probe-3 provides the fixed φ value at the mixture cell. The expression to estimate ϕ at the mixture cell assumes that the gradients of ϕ at points “a” and “b” are approximately equal. This assumption is valid if the distance between points “a” and “b” is small. Under this assumption, Eq. (6) determines the fixed value at the mixture cell ϕ_{M}.

$${φ}_{M} = {φ}_{sat} + {d}_{1} \frac{( {φ}_{I} - {φ}_{in} )}{{d}_{3}} \qquad ( 6 )$$

The present method finds the fixed value at the mixture cell ϕ_{M} and the mass transfer through the interface with the gradient of ϕ at the interface.

To summarize the present method, two are the main difficulties in a simulation of multiphase flows: (1) include the edge or interface that divides two or more fluids (2) compute the mass transfer or transport of species across the interface. To address these difficulties, the present method injects three probes. The probes, which are perpendicular to the interface, connect the interface with the center of the mixture cell and with the center of the I-cell. The length of the probes and the values of ϕ at the origin and tip of the probes determine gradients of ϕ at the interface. These gradients are the basis of the expressions that find the mass transfer through the interface Eq. (5) and the value of ϕ for the mixture cell Eq. (6).

The present method is applicable in the field of simulations with internal interfaces or complex geometrical boundaries. Examples include, but are not limited to the following studies: Simulations of boiling, evaporation, and condensation of pure fluids or binary or multicomponent mixtures. In these simulations, a dynamic interface divides the liquid and vapor phases. The interface has a temperature Tₛₐₜ. In addition, there is mass transfer through the interface, which depends on the temperature gradient at the interface; Simulations of biological systems. Internally, a biological system is composed of veins and arteries. The internal structure of biological systems might form interfaces that divide the tissue from the blood flow through the veins. In the simulation of biological systems the veins or arteries pass through computational cells. Therefore, for example, the present method could be used to determine the temperature of the computational cells that have a vein; and Simulations with complex geometries. A complex geometry has non-uniform boundaries. Simulations with these geometries require deformed grids to consider the shape of the boundaries. The present method allows the use of uniform grid while maintaining the non-uniform boundary. This can be done by considering the non-uniform boundary as an interface that passes through various uniform cells. The present method can be used to determine the temperature of the cells that have an interface.

The method can be used to simulate internal boundaries in commercial numerical software such as ANSYS-Fluent, Flow3D, OpenFOAM, FUN3D, COMSOL. These simulation packages commercialize modules that perform simulations.

The method is attractive for the development of a software package or module to simulate systems with internal boundaries. These packages could be oriented towards the simulation of evaporative interfaces, mass transport at interfaces, biological systems with arteriovenous structures, interaction of multiple phases, and the like.

A major possible use is the development of a simulation package dedicated to the analysis of phase-change. Applications of phase-change are found in electronics cooling, nuclear and fossil fuel power steam generators, distillation columns, concentrated solar power systems, glass furnace melting processes, water desalination, heat and mass exchangers, just to mention a few. The present method provides a simpler and accurate alternative to capture the interaction between the two phases and the mass transfer at the interface.

Commercial systems for cancer detection rely on computer simulations to find the tumor size and location. Examples of these commercial systems are Sentinel BreastScan and NoTouch BreastScan. These systems ignore the arteriovenous structure. This assumption might lead to inaccurate predictions of the tumor position and size. The present method can integrate the arteriovenous structure in the simulation of cancer tumors, which could increase the reliability of these commercial systems.

The method could be applied for the simulation of structures with complex boundaries. Applications of these structures include crystal growth, airfoils, and modified surfaces with non-uniform features.

Simulations of systems where a phase (liquid, gas, or solid) travels inside a different phase. Simulations predict the thermal and fluid dynamic behavior between phases in system that have fluid-fluid interactions or fluid-solid interactions. Applications of these systems include drug delivery systems, water desalination, interacting bubble flow, distillation, ink printing, just to mention a few. An interface with a physical velocity affects the velocity of the surrounding fluid. The present approach predicts these effects by considering the interface velocity and the velocity of the surrounding computational cells.

Systems that use a laser with a specific temperature or velocity to heat or cool a particular area. An application is the cancer treatment with cryosurgery. In cryosurgery, a moving laser is used to kill unhealthy biological cells. Predictive simulations determine the time, strength, and location of the applied laser source. These simulations characterize the laser effect as a moving source inside the computational domain. The moving source might have a constant temperature. The present method could include the laser effect with a uniform computational grid and with conventional discretization schemes.

Interfacial phenomena are encountered in many applications, including boiling used for cooling of high-power electronic devices, steam generation found in nuclear and fossil fuel powered plants, solidification found in 3D additive printing, and the like. Simulations of interfacial phenomena are useful to understand and predict the phase-change processes that occur around the interface at various operating conditions; this information is important to optimize the performance of such applications.

Current numerical packages try to increase their sales by simulating interfacial phenomena. However, these numerical packages make important assumptions that lead to inaccurate predictions, which reduce their sales. For instance, ANSYS-Fluent uses a method that relies on empirical coefficients to estimate mass transfer at the interface; such a method makes the unrealistic assumption of interface displacement independent of conditions near the interface. Other companies prefer to restrict their software to applications with multiphase flows without mass transfer at expenses of sacrificing customers. For example, STAR-CCM+ sells modules to simulate multiphase flows that focus only on the interaction between the two phases, but that are unable to predict interfacial mass transfer.

The present method improves the accuracy of numerical software or calculation procedure that simulates multiphase flows with heat and or mass transfer. A comparison of the numerical and theoretical interface displacement of a planar interface indicates that that a simulation in ANSYS-Fluent has a relative error of more than 300% whereas a simulation with the present methods has a relative error of 0.2%. In addition, the simulation of bubble growth indicates that ANSYS-Fluent has inaccurate temperatures near the bubble edge that are below the minimum possible temperature (saturation temperature) whereas the simulation with the present method has accurate temperatures that are between the expected limits. In addition, results of the simulation of bubble growth over a heated surface compare well with theoretical data of change in bubble radius with time.

The present method will improve numerical packages by providing a less complex alternative to include simulations of multiphase flows with interfacial mass transfer while keeping accuracy. First, the present method requires the identification of just one cell instead of three or six computational cells required by other conventional methods. Second, the present method uses direct estimations instead of the solution of a system of equations. Relative to the conventional method that requires the identification of six cells and that solves a system of equations, the present method reduces the number of operations from 2.5 million to 6,000 at each iteration. A comparison against theoretical mass transfer rates in a spherical bubble indicates that the present method has a maximum relative error of less than 4% whereas methods that require six or three computational cells have maximum relative errors of 25% and 6%, respectively. The fewer number of operations has a slight impact on the speed of the simulation as well; with a conventional Intel core i3 CPU of 1.8 GHz, the present method reduces the time of the simulation by 25 minutes (the total simulation time is of the order of 48 hrs).

Interfacial phenomena are encountered in many applications, including boiling used for cooling of high-power electronic devices, steam generation found in nuclear and fossil fuel powered plants, solidification found in 3D additive printing, just to mention a few. Simulations of interfacial phenomena are useful to understand and predict the phase-change processes that occur around the interface at various operating conditions; this information is important to optimize the performance of such applications. Prior numerical packages try to increase their sales by simulating interfacial phenomena. However, these numerical packages make important assumptions that lead to inaccurate predictions, which reduces their sales. For instance, ANSYS-Fluent uses a method that relies on empirical coefficients to estimate mass transfer at the interface; such a method makes the unrealistic assumption of interface displacement independent of conditions near the interface. Other companies prefer to restrict their software to applications with multiphase flows without mass transfer at expenses of sacrificing customers. For example, STAR-CCM+ sells modules to simulate multiphase flows that focus only on the interaction between the two phases, but that are unable to predict interfacial mass transfer. The present invention describes a method that simplifies the simulation of interfaces and the transport processes occurring across the interfaces. The method accurately determines the fixed ϕ value at the computational cells that have an interface (mixture cells), which is needed for a proper representation of the interface. Moreover, the method accurately determines the gradient of ϕ at the interface, which is needed for a proper estimation of the mass transfer at the interface. A comparison of the numerical and theoretical interface displacement of a planar interface indicates that that a simulation in ANSYS-Fluent has a relative error of more than 300% whereas a simulation with the proposed methods has a relative error of 0.2%. A comparison against theoretical mass transfer rates in a spherical bubble indicates that the proposed method has a maximum relative error of less than 4% whereas methods that require six or three computational cells have maximum relative errors of 25% and 6%, respectively. The proposed method will improve the numerical packages by providing a less complex alternative to include simulations of multiphase flows with interfacial mass transfer while improving accuracy.

An embodiment includes injecting three probes that are perpendicular (or normal) to the interface. Probe-1 supports the injection of probe-2. Probe-1 and probe-2 support the construction of probe-3. The importance of probe-3 is its orientation and its length; this probe is normal to the interface, and has a length such that the tip of the probe intersects a cell center on a phase. The method includes:
injecting probe-1 based on the identification of the computational cell that has an interface (mixture cell). The origin of probe-1 is the mixture cell center, the orientation is normal to the interface, and the tip of the probe is the intersection of the probe with the interface. The point that intersects the probe with the interface is called “point a”. The length of the probe-1 is given by d₁, the length of the probe is determined based on the origin and the tip of probe-1.
injecting probe-2 based on the tip of the probe-1 “point a”. The origin of probe-2 is “point a”, the orientation is normal to the interface, and the length is d₂.
using probe-2 to identify the center of computational cell in a phase that is closest to the interface along the normal direction (The name of the nearest cell is “I-cell”).
exploring a region that uses the tip of probe-2 as a reference point to find the center of the cell that is nearest to the interface along the normal direction (the center of the “I-cell”). The center of the explored region corresponds to the location of the tip of probe-2. The dimensions of the explored region are Δx in the x-direction, Δy in the y-direction, and Δz in the z-direction, where x, y, and z represent the coordinates of a Cartesian system. Ox, Δy, and Δz are the lengths of the computational cells in the x, y, and z, directions, respectively.
using the I-cell to inject the probe-3. The origin of the probe-3 is the center of the I-cell, the orientation is normal to the interface, and the length is determined by the projection (or dot-product) of the vector \vec{r_{I}} on the unit vector that is normal to the interface \hat{n} (d₃=\vec{r_{I}}·\hat{n}). \vec{r_{I}} is a vector that connects the center of the I-cell with the “point a” at the interface.
using the lengths of probe-1 “d₁” and probe “d₃” and the values of the variable j at the extremes of the probes to determine the value ϕ_{M} of the computational cells that have an interface (mixture cells).
determining the fixed value ϕ_{M} by adding the product of the length of the probe-1 “d₁” with the gradient of the variable ϕ at point “a” to the value of the variable ϕ at the interface, ϕ_{M}=ϕᵢₙ+d₁ (ϕ_{I}−ϕᵢₙ)/d₃. ϕᵢₙ is the value of the variable ϕ at the interface and ϕ_{I} is the value of the variable ϕ inside the computational cell-I.
using the lengths of probe-1 “d₁” and probe “d₃” and the values of the variable ϕ at the extremes of the probes to determine the transport of mass or species or any other transport across the interface.
determining the transport of mass or species m″ by the product of a parameter α and the gradient of the variable ϕ at point “a”, m″=α(ϕ_{I}−ϕᵢₙ)/d₃. Where a is constant or a variable parameter that depends on the properties of the fluids or phases in the simulation.
estimating the length of the probe-2 based on the dimensions of the mixture-cell. The length of probe-2 d₂ in step 3) is such that the tip of probe-2 lies outside of the mixture cell.
identifying the center of the I-cell based on the tip of probe-2 and a explored region. The length of the explored region is given the dimensions of the computational cells (Δx, Δy, and Δz) or by any other parameters.

The application of the proposed method in computational grids that contain cells of various shapes including but not limited to triangles, tetrahedron, prism, pyramid, or arbitrary polyhedrons. The computational grid could have computational cells of similar or different lengths.

The application of the proposed method to computer simulations in 1-dimensional, 2-dimensional, or 3-dimensional analyses in Cartesian, cylindrical, spherical, or other kind of coordinates.

The application of the proposed method in numerical packages such as ANSYS-Fluent, Flow3D, OpenFOAM, FUN3D, COMSOL, STAR-CCM+ just to mention a few.

The disclosure will be further illustrated with reference to the following specific examples. It is understood that these examples are given by way of illustration and are not meant to limit the disclosure or the claims to follow.

### Example 1

The present invention proposes a method that improves the accuracy on the definition of the interface and on the computation of the interfacial mass transfer. The method applies for interfaces with any orientation and position. The method is free of interpolation function since it ignores the temperature of the mixture cell. To provide evidence of these facts, this section compares the proposed model for mass transfer Eq. (5) against the methods proposed by Ling et al., Udaykumar and Shyy, and Sato and Niceno. The comparison evaluates the accuracy of each method for determining the temperature gradient needed to include the interface and to compute the mass or species transport across the interface.

To perform this task, ideal scenarios were recreated at three different locations along the interface of a spherical bubble. The radius of the spherical bubble is R₀=0.1 mm, and the scenarios lie at angles of inclination 5, 20 and 40° along the interface. The components of the scenario are the interface and nine cells. The nine cells represent the computational cells that would appear in the estimation of the temperature gradient in the simulation. The temperature of the cells is the theoretical temperature field and with the radial position of the cell centers. The temperature field corresponds to a growing spherical bubble with a superheat level of 5 K and with fluid properties of water at 1 atm. The size of the cells is 1 μm.

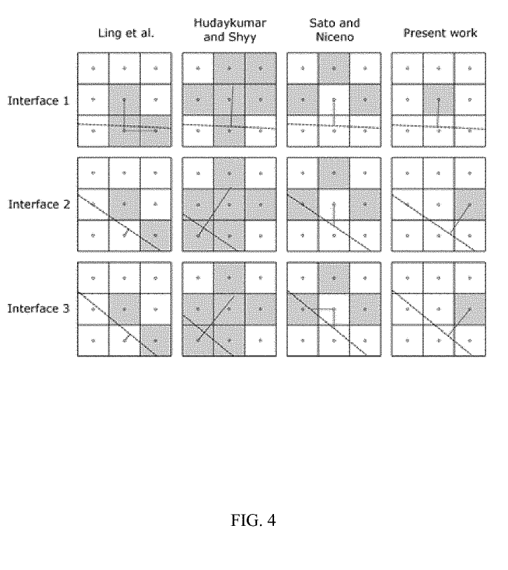

FIG. 4 shows the three different recreated scenarios for each method. The diagrams use gray color and lines to highlight the cells and probes needed for the estimation of the temperature gradient. The section above provides an explanation of the particular procedures on each method. It is important to observe that the methods of Ling et al. and Udaykumar and Shyy use the temperature of the mixture cell, which represents a disadvantage since the temperature of this cell requires an extra interpolation procedure. Sato and Niceno proposed a method that estimates the temperature gradient by taking into account the interface temperature and position, but the temperature gradient is estimated at the neighboring cell center rather than at the interface. Moreover, in some scenarios the method of Sato and Niceno uses interpolation procedures to find the temperature of the adjacent cells that have an interface (see for instance the cases with interface-2 and interface-3). The present method ignores the mixture cell and estimates the temperature gradient at the interface. In addition, the present method requires the control of fewer cells around the interface, which reduces the complexity of developing the computer codes for the mass transfer estimation.

TABLE 1
Computation of temperature gradients with various methods.

| Authors | Interface-1 | Interface-2 | Interface-3 |
|---|---|---|---|
| Ling et al. | 0.921 (38%) | 1.478 (1.98%) | 1.306 (13.39%) |
| Udaykumar and | 1.422 (5.8%) | 1.428 (5.3%) | 1.428 (5.3%) |
| Shyy | | | |
| Sato and Niceno | 1.144 (24.1%) | 1.129 (25.1%) | 1.489 (1.26%) |
| Present invention | 1.481 (1.79%) | 1.470 (2.5%) | 1.445 (4.17%) |

Table 1 shows the results of the estimation of the temperature gradients with the various approaches shown in FIG. 4. The units are MK/m. The values in parenthesis indicate the relative error. The theoretical temperature gradient corresponds to 1.58×10⁶ K/m.

The results indicate that the method of Udaykumar and Shyy has a relative error in the range of 5.3% to 5.8%. We observed that a similar error was obtained if the temperature at the tip of the probe was estimated with the theoretical equation rather than the polynomial function. We also observed that the error was reduced to 1.2% if a second order backward approximation was adopted. Therefore, the 5% error is mainly due to the adoption of a first order backward approximation for the estimation of the temperature gradient. Other important fact is that the method of Udaykumar and Shyy provides equivalent temperature gradients with interface 1, 2 and 3. This is because the method determines the gradient with a probe of equal length on each interface analyzed.

The 38% in error with interface-1 indicates that the method of Ling et al. is inappropriate for interfaces that have a small angle of inclination. To reduce the error on these interfaces the authors have proposed alternative procedures. The results also show that the method proposed by Ling et al. is minimal (1.98%) with interface-2, but it increases to 13.39% with interface-3. The reason of this trend is that the method estimates the temperature gradient at the mixture cell center. Therefore, the minimal error is because interface-2 is closer to the mixture cell center relative to interface-3. The results indicate that the assumption of the temperature gradient at the mixture cell center may lead to significant errors when the interface is far from this cell center.

The method proposed by Sato and Niceno shows errors of the order of 20% with interface-1 and interface-2, and the error is minimal and equal to 1.26% with interface-3. The error is significant with interface-1 and interface-2 because these interfaces are far from the neighboring cell center, which is the location at which the temperature gradient is estimated. The small error with interface-3 is due to the short distance between the interface and the neighboring cell center. Also, the estimation assumes a second order approximation, which contributes to reduce the magnitude of the error.

The method of the present invention has an accuracy that is better than the sophisticated method of Udaykumar and Shyy. The method of Udaykumar and Shyy has a relative error in the range of 5.8% to 5.3% whereas the present method has a relative error is in the range of 1.79% to 4.17%. Also, different to the methods of Ling et al. and Sato and Niceno, the accuracy is maintained for all the analyzed interfaces with the present method. The error is only 1.79% with interface-1, and the error increases to 4.17% with interface-3. The variation is due to the change in length of the probe used for the estimation of the gradient. In the present method, the length of the probe that finds the gradient is defined by the distance from the I-cell center to the interface, which is not always the same in all the mixture cells. However, it is important to emphasize that the simulation of bubble growth indicates that these small variations have a null influence on the interface shape.

Table 2 presents a brief description of the main features of the various analyzed approaches. The information in the table shows that the present method is more accurate than the actual methods in the technical literature. Only the present method and the method of Udaykumar and Shyy estimate the temperature gradient at the interface, which helps to improve the accuracy of the mass transfer computation. Other methods assume a temperature gradient at a cell center. Another important fact is that the present method requires the identification of only one computational cell in the phase, which reduces the complexity of computing the mass transfer. Besides, the present method is free of interpolations functions since it ignores the mixture cell temperature. Although it is not highlighted in the table, the analysis showed that the present method applies for interfaces of different orientation and position. These characteristics provide strong evidences of the importance of the present method in simulations with interfacial mass transfer.

TABLE 2
General terms of the various approaches
for the computation of mass transfer.

| | | | Number | Requires |
|---|---|---|---|---|
| | Relative | Location of ∇T | of cells | interpolation |
| Method | error (%)* | estimation | involved | functions |
| Ling et al. | 2.0-38 | Mixture cell | 3 | Yes |
| | | center | | |
| Udaykumar and | 5.3-5.8 | Interface | 6 | Yes |
| Shyy | | | | |
| Sato and Niceno | 1.3-24.1 | Neighboring | 3 | Yes |
| | | cell center | | |
| Present invention | 1.7-4.2 | Interface | 1 | No |

Determined with a spherical bubble of radius 0.1 mm. Δx=1 μm, water properties 1 atm.

### Example 2

Various concepts in the present method are not technical and were proposed based on intuitive understanding. For instance, the identification of the cell of a phase closest to the interface is based on the exploration of an area around the tip of probe-2. This procedure was proposed based on analysis of the cells around the interface and the location of probe-2. To perform this task, diagrams of the interface and cells around the interface were created within the software AutoCAD. Another example is the construction of the probe-3 with the support of probe-1 and probe-2. The length of the probe is determined by the projection of two vectors. This step was defined with the help of diagrams around the interface and by applying fundamental concepts of vector analysis.

The conception of the method was through direct estimation of the temperature distribution around an evaporative interface. For the estimation, we used theoretical equations that provided full control of the interface position and temperature of multiple locations around the interface. The use of theoretical equations to represent the temperature field around the interface provides direct access to the heat and mass transfer phenomena at the interface level. This theoretical information allowed a unique understanding of the relation between the interface, the temperature of different locations around the interface, and the gradients of temperature at the interface.

The present method allows a precise modeling of interfaces. The application of the method in a multiphase simulation provides a proper representation of the variable ϕ around the interface, and an accurate computation of the mass transfer through the interface.

To illustrate these facts, a multiphase simulation with interfacial mass transfer was considered. The problem consists of a growing spherical bubble, where the mass transfer depends on the gradient of temperature at the interface. A spherical bubble has two phases: phase-1 is vapor inside the bubble, and phase-2 is liquid outside the bubble. The main advantage of simulating a spherical bubble is the existence of theoretical solutions for the temperature of the liquid phase and the change in bubble radius as a function of time. Such theoretical equations can evaluate the accuracy of the present method.

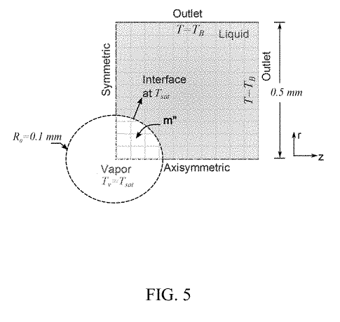

FIG. 5 shows the dimensions, the boundaries, and the initial conditions in the simulation. In this simulation, the computational domain is a square of length 0.5 mm. The computational domain has square computational cells with a length that ranges from 1 to 0.6 μm. The interface that divides the vapor and liquid passes through various computational cells. The initial bubble radius is R₀=0.1 mm, which corresponds to a theoretical time of 0.068 ms. The simulation has boundary conditions of axisymmetric at the bottom boundary, symmetric at the vertical boundary in contact with the bubble, and pressure outlet at the other boundaries. Under these conditions, the computational domain is a two dimensional plane with cell volumes that correspond to the circumferential shape, and only one quarter of the bubble is simulated.

The operating conditions in the simulation are vapor which remains with a constant saturation temperature equal to Tₛₐₜ=373.15 K. The interface temperature remains constant and equal to the saturation temperature. The liquid temperature changes from 373.15 K at the interface to T_{B}=378.15 K at a certain distance from the interface. The fluid properties correspond to water at 1 atm. These conditions result in the formation of a thin thermal film around the interface. The initial thickness of the thermal film is 12 μm.

The simulation of the growing bubble adopts two different approaches to characterize the temperature of the mixture cells. One case uses the present method to fix the temperature of the mixture cells. The other case uses average properties (density and thermal conductivity) at the mixture cells. The evaporation of the liquid in both cases considers with the present method to compute the mas transfer. The main objective of performing the simulation with two different cases is to visualize the effect of the mixture cells characterization on the temperature field around the interface.

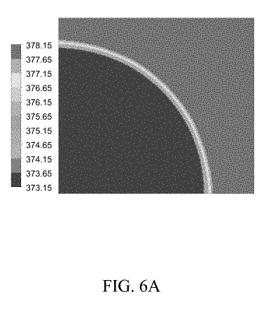

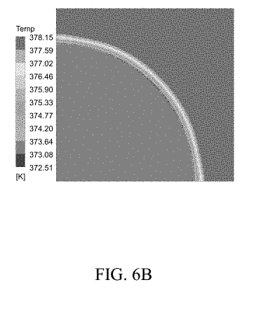

FIG. 6 shows the temperature distribution in both vapor and liquid phases for the two different analyzed cases. The results in FIG. 6A indicate that the simulation with the present method has uniform temperatures around the interface. Other important fact is that the temperature is in the range of 373.15 to 378.15 K, which is the range of operation of the simulation. The results in FIG. 6B indicate that the simulation with average properties has temperatures that are out of range. The temperature contour shows the presence of cells with a temperature below 373.15 K. These cells appear on the liquid side and are close to the interface. These out of range temperatures appear due to the incorrect characterization of the mixture cells. The results indicate that the present method leads to accurate temperatures around the interface in a multiphase simulation such as bubble growth in a superheated liquid. These results provide evidence of the importance of properly accounting for the conditions at the mixture cells.

The interface effects in the solution of the energy equation are included by fixing the temperature of the mixture cells. In the simulation, Eq. (6) determines the fixed or imposed mixture cell temperature based on the temperature gradient at the interface. To assess the validity of Eq. (6), we compared the theoretical mixture temperature with the computed interface cell temperature. The procedure required the identification of the mixture and I cells along the interface, and the estimation of the temperature gradient with Eqs. (4)-(5). Scriven's theoretical solution determined the theoretical temperature of the mixture cell.

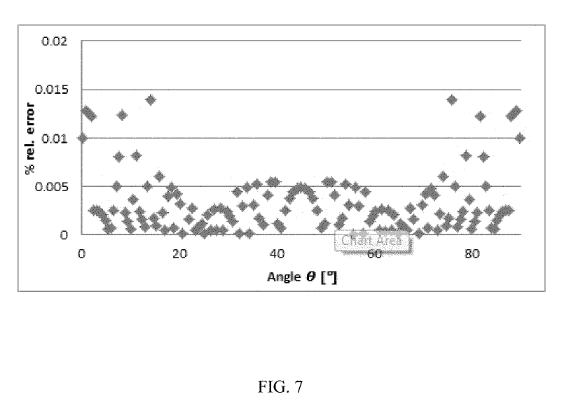

FIG. 7 shows the relative error of the mixture temperature along the interface. The angle θ is measured from the vertical boundary in the clockwise direction. The results indicate that numerical and theoretical values differ in less than 0.015%. The results show that the present method accurately predicts the mixture cell temperature by evaluating the temperature gradient at the interface with two different cell temperatures (the mixture cell temperature and the I-cell temperature). The small variations are due to the assumption of equal temperature gradients at the interface in two different locations. This assumption introduces small errors since the temperature gradients are calculated with probes of different length and position. However, the results indicate that the method provides an accurate prediction of the temperature of the mixture cells.

The simulation of spherical bubble growth shows the verification and proof of concept of the present method. The main advantage of this simulation is the existence of theoretical solutions for the temperature distribution and the interface displacement. A comparison between the theoretical solutions and the results of the simulation provides evidence of a proper mass transfer computation and correct temperatures of the mixture cells. The conditions of the simulation are described in FIG. 5 which shows a schematic diagram of the performed simulation.

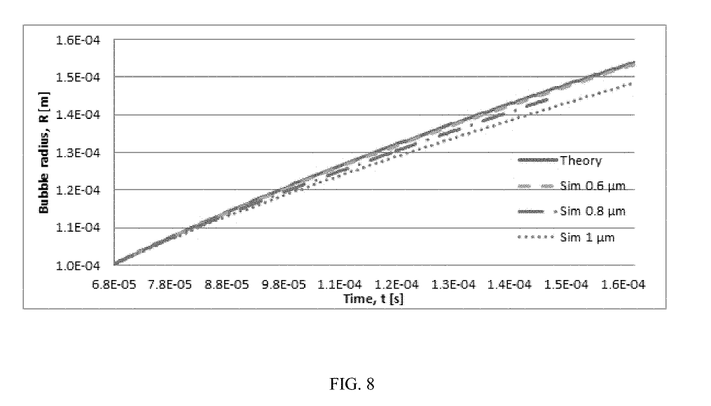

The numerical and theoretical bubble radius were compared to evaluate the accuracy of the simulation. The numerical bubble radius was calculated with the vapor volume by assuming a spherical bubble. The theoretical bubble radius was calculated with the theoretical solution. FIG. 8 compares the computed and the theoretical bubble radius. The computational domain had grid cell sizes of 1, 0.8 and 0.6 μm. The results indicate that the computed bubble radius agrees with Scriven's solution and that the accuracy of the simulation improves as the grid cell size is reduced. The relative error at 1.18 ms is 2.24, 0.83, and 0.24% with grid cell sizes of 1, 0.8, and 0.6 μm. The improvement is due to the higher grid resolution in the thermal film obtained with smaller grid cells. The number of cells in the thermal film at the beginning of the simulation is 12, 15, and 20 for grid cell sizes of 1, 0.8, and 0.6 μm, respectively. The agreement between the theory and the simulation proves the validity of the present methods to compute the mass transfer at the interface with Eq. (5) and the temperature of the mixture cells with Eq. (6).

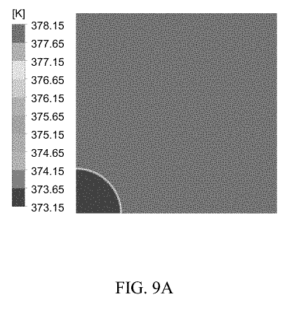

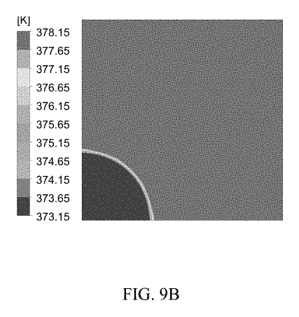

Proper temperature distributions around the interface require of special numerical practices at the mixture and neighboring cells. Errors in the temperature field directly affect the bubble growth rate and the heat transfer mechanisms near the interface. Contours of temperature in a non-adiabatic bubble growth provide direct evidence of the thermal behavior around the interface. FIG. 9 shows the temperature fields at 0.08 (FIG. 9A) and 0.12 ms (FIG. 9B). The results indicate that the simulation provides uniform temperature distribution around the interface. These results imply that the interface is correctly considered as a moving boundary in the solution of the energy equation. Other import fact is that the thermal film remains thin during the bubble growth process. The thermal film is not consumed during the bubble growth process, but it moves along with the surface due to the convective transport. At the same time, the thickness of the thermal film increases with time due to the diffusive transport. The results in FIG. 9B show a slight increment of the thermal boundary layer near the domain boundaries. A similar trend was also observed by Sato and Niceno. This behavior might be due to the presence of slightly higher velocities near the boundaries. Nevertheless, the adopted approach provides a reasonable prediction of the thermal behavior around the interface during bubble growth.

To our knowledge, only the work of Sato and Niceno has reported the temperature distribution around the interface in spherical bubble growth. However, Sato and Niceno used a method to calculate the mass transfer with the temperature gradient at the neighboring cell center. The authors also developed an in-house code to develop the simulation. Therefore, the present work might be the first numerical work that has shown proper temperature distributions at the interface in the simulation of spherical bubble growth while using numerical software. This was possible by proposing methods that simplify the numerical practices needed to accurately capture the interfacial heat and mass transfer processes in bubble growth.

### Example 3

the acronym OCASIMAT stands for One-Cell Algorithm for Sharp Interface and Mass Transfer according to the present method.

Identification of the I-cell.

The cell that computes the temperature gradients is a cell whose cell center lies in a direction normal to the interface. For convenience, the cell that computes the gradient of ϕ at the interface is named as “I-cell”.

In the simulation of planar interfaces, the center of the I-cell is located in a direction perpendicular to the interface. In simulations with curved interfaces in two-dimensions, the center of the I-cell is located in a direction perpendicular to the interface. In simulations with curved interfaces in three-dimensions, the center of the I-cell lies in a direction orthogonal to the interface.

The method employs the center of the I-cell to compute the gradient ϕ. However, any other location of a computational cell could be used to compute such a gradient.

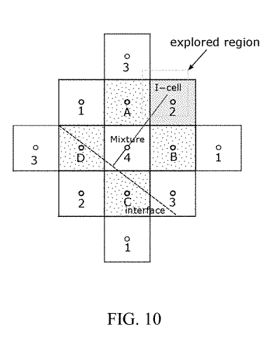

FIG. 10 shows a possible method to explore the region around the mixture cell to identify the I-cell. The method identifies the I-cell with loops that surround the mixture and the neighboring cells. The method visits the cells that surround the mixture cell. These “neighboring cells” are A, B, C, and D in the figure. At the same time, the method visits the cells that surround the neighboring cells. These cells are 1, 2, 3, and 4 in the figure. The cells A-D and 1-4 are all possible I-cells. The cell with a center inside the explored region is the desired I-cell. Other less robust methods to find the I-cell could visit fewer cells around the mixture cell, or could adopt other identification alternatives.

Estimation of mass transfer along a spherical interface.

This section shows the accuracy of the present method to estimate the mass transfer along an evaporative interface. The main objective is to analyze the performance of the method with interfaces of different orientations and with domains of various grid cell sizes. Although the present analysis considers the estimation of the mass transfer with the gradient of the variable ϕ (where ϕ is the temperature), it is important to emphasize that the method could be used to determine any other quantity whose magnitude depends on the gradient of the variable ϕ at the interface. These quantities could include but are not limited to electric potentials, electric fields, species transport, momentum transport, etc.

To perform this task, we evaluated the temperature gradients along the periphery of a 2D-axisymmetric bubble. The computation domain had a bubble of a specific radius. The bubble patch had reconstructed interfaces. With the initial patch, an algorithm identified the G-cells and retrieved the corresponding coordinates. These coordinates and Scriven's solution provided the G-cell temperature, which determined the numerical temperature gradient ∇Tₙᵤₘ with Eq. (4).

The analysis considered two bubble radii of 0.1 mm and 1 mm. For a 0.1 mm, the length of the computational domain was 0.15 mm and the analyzed grid cell sizes were 1, 0.6, and 0.2 μm. For a radius of 1 mm, the length of the computational domain was 1.5 mm and the analyzed grid cell sizes were 10, 6, and 2 μm.

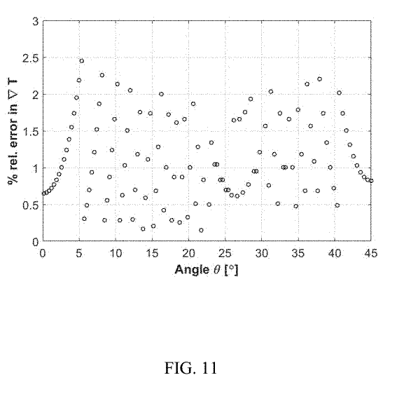

FIG. 11 shows the relative error of the temperature gradient on each G-cell along the interface. In the plot, θ is the angle measured from the vertical symmetrical axis along the clockwise direction. The plot shows results in a range from 0 to 45°, and similar results were observed in the range 45 to 90° with a symmetric line at θ=45°. The results correspond to a bubble of radius is 0.1 mm and to a grid cell size of 0.6 μm. The relative error is equal to (∇Tₜₕ−∇Tₙᵤₘ)/∇Tₜₕ×100, where the theoretical temperature gradient is given by the derivative of Eq. (22) evaluated at the radial location of the interface.

FIG. 11 shows that the relative error follows an oscillatory trend along θ. The range of the relative error is 0.2 to 2.5%. From 0 to 5° the relative error increases and the distance between the G-cell center and the interface (length of probe-3 d₃) is proportional to θ. This is because the radial position of the G-cells remains constant, while the interface bends towards central axis. Around 5°, the relative error changes from 2.5% to 0.3% since the G-cell moved one cell below. A similar behavior occurs from 5 to 8°, the radial position of the G-cell remains constant, and the relative error augments because d₃ increases. These results show that the relative error is proportional to the length of probe-3. In the present approach, the maximum length of probe-3 is d₃=\sqrt{(1.5Δs)²+(1.5Δs)²}, which occurs when the interface is oriented at 45° and lies near the corner of the mixture cell. The results indicate that with a grid cell size of 0.6 μm, the maximum relative error is 2.5%. This error is small and might insignificantly influence the bubble growth rate.

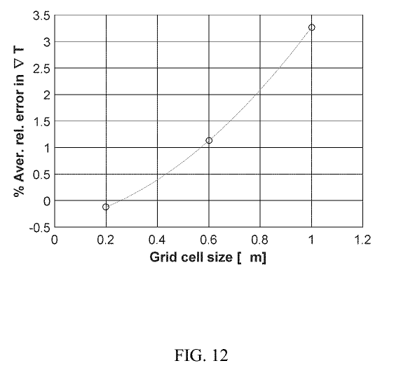

FIG. 12 shows the average relative errors in the estimation of the interfacial temperature gradient. The analysis considered a bubble with a radius of 0.1 mm and with grid cell sizes of 1, 0.6, and 0.2 μm. The average relative error is Σ₀ⁿ% rel. errorᵢ/n, where n is the total number of mixture cells.

FIG. 12 shows a reduction in the average relative error as the grid is refined. The accuracy follows a quadratic trend despite the fact that the temperature gradient assumes a first order approximation. The deviations from the linear trend occur because the estimation of temperature gradient is along the normal direction and not along vertical or horizontal directions. As a result, the change in the grid cell size is not equivalent to the change in distance in the estimation of the temperature gradient. The non-linear dependence is stronger as the interface inclination gets closer to 45°. These results show that the present method takes more advantage of a reduction of the cell size relative to other approaches with gradients along Cartesian directions.

Another important result in FIG. 12 is that small grid cell sizes lead to negative average relative errors. The negative value indicates that in some cells the numerical temperature gradient is greater than the theoretical temperature gradient. The relative error becomes negative when the distance between the G-cell and the interface d₃ is shorter than 0.25 μm. This occurs because the temperature gradient increases as the length d₃ becomes smaller. In fact, the limit of the temperature gradient as d₃ approaches zero is infinite. However, with the present method, the shortest distance is Δs/2 since the method locates the G-cell in the neighboring cells (cells around the mixture cell).

Table 3 shows the results obtained for a bubble radius of 1 mm with grid cell sizes of 10, 6, and 2 μm. The small relative errors show that the present method works with bigger bubbles and with larger computational cells. The maximum relative error is small and the magnitude decreases with smaller grid cell sizes. The results indicate that bubble radii of 0.1 mm and 1 mm have equivalent relative errors. This occurs because in spherical bubble growth, the thickness of the thermal film is proportional to the size of the bubble. For example, the thickness of the thermal film is 12 μm with a bubble radius R=0.1 mm, whereas the thickness of the thermal film is 120 μm with a bubble radius R=1 mm.

TABLE 3
Accuracy of the present method to estimate mass transfer
with various grid cell sizes. Bubble radius of 1 mm.

| Grid cell size | | | |
|---|---|---|---|
| (μm) | Min. % rel. error | Max. % rel. error | Aver. % rel. error |
| 10 | 0.75 | 6.33 | 3.27 |
| 6 | 0.21 | 2.45 | 1.13 |
| 2 | −0.33 | 0.11 | −0.12 |

Estimation of mixture cell temperature along a spherical interface.

This section evaluates the accuracy of OCASIMAT to estimate the temperature of the mixture cells. The present method uses a mathematical expression to determine the temperature of the mixture cells Eq. (6). The derivation of this expression assumes a linear temperature profile near the interface. The linear temperature profile is a valid assumption as long as the points used to estimate the temperature gradient remain close to the interface. Under this assumption, the temperature gradients obtained with two different points are equivalent if these points are located along a direction perpendicular to the interface. It is worth to mention that the present analysis uses the present method to determine the temperature of the mixture cells. However, the method applies for the estimation of magnitude of any variable ϕ on the mixture cells. Possible applications include but are not limited to electric or magnetic fields, chemical species distribution, velocity fields, etc.

To analyze the accuracy of the present approach on determining the temperature of the mixture cell, we considered a spherical bubble of radius R₀=0.1 mm with the initial temperature profile. The numerical temperature of the mixture cells was determined with Eq. (6). To compare the numerical temperatures, Scriven's solution determined the theoretical mixture cell temperatures. The percentage of relative error is given by (T_{M,th}−T_{M,num})/T_{M.th}×100.

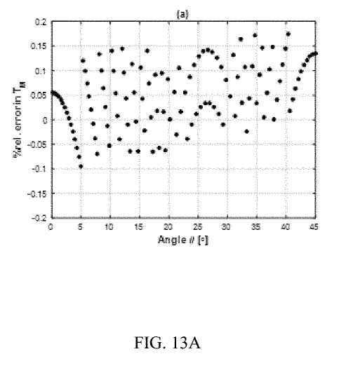

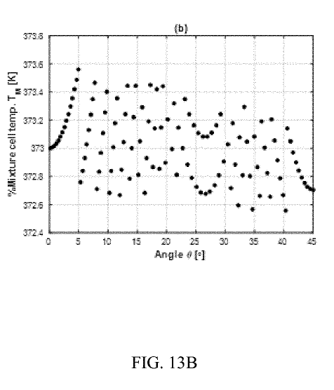

FIG. 13A shows the relative error of the temperature on each mixture cell along the interface with a grid cell size is 0.6 μm. The results show a relative error in the range −0.1 to 0.17%. In addition, the relative error changes from positive to negative values as the interface moves through the mixture cell. For example, in the range 0 to 2.5° the relative error decreases from 0.05 to 0%, and in the range 2.5 to 5°, the relative error becomes negative. At 5° the error varies from −0.1 to 0.12%, which is due to a change in the radial location of the G-cell; this jump increases the distance between the G-cell and the interface d₃. These results show that the relative error decreases as the interface gets closer to the mixture cell center, and the relative error is zero when the interface is in contact with the mixture cell center.

FIG. 13B shows the temperature of the mixture cells along the interface. The results indicate that the temperature of the mixture cells oscillates around the saturation temperature Tₛₐₜ=373.15 K. The magnitude of the mixture cell temperature depends on the position of the interface: T_{M}<Tₛₐₜ when the interface lies above the mixture cell center, and T_{M}>Tₛₐₜ when the interface lies below the mixture cell center. These results show that the estimated value for the mixture cell temperature preserves the temperature profile near the interface, which helps to compute accurate temperature gradients at the faces of the mixture cells.

Table 4 shows the relative errors of the estimated mixture cells temperatures for grid cell sizes of 1, 0.6, and 0.2 μm. Results show maximum relative errors of 0.25%; this error can be reduce to 0.07% by augmenting the grid cell resolution. The average relative error is smaller than 0.08%, which shows that the present method accurately determines the temperature of the mixture cells. The dependence between the grid cell size and the average relative error follows a linear trend. This trend occurs because the method performs a linear interpolation along the direction normal to the interface to find the temperature of the mixture cell.

TABLE 4
Accuracy of the present method to estimate mixture cell temperature
with various grid cell sizes. Bubble radius of 0.1 mm.

| Grid cell size | | | |
|---|---|---|---|
| (μm) | Min. % rel. error | Max. % rel. error | Aver. % rel. error |
| 1 | −0.14 | 0.25 | 0.077 |
| 0.6 | −0.09 | 0.17 | 0.051 |
| 0.2 | −0.01 | 0.07 | 0.028 |

### Example 4

Discretization and Implementation of a Sharp Interface Model for Interfacial Mass Transfer During Bubble Growth.

The numerical simulation of interfacial phase-change was performed in ANSYS-Fluent, which solves the governing equations for mass, momentum, and energy conservation. Also, the simulation software solves the VOF tracking interface algorithm. At the present time, the numerical solver lacks a mass transfer model that is based on the heat flux at the interface. Moreover, the numerical software assumes average properties at the mixture cells to solve the energy transport equation, which lead to inaccurate interface displacements. In the present invention, the software was customized to ensure an accurate phase-change simulation. UDFs were used to identify the mixture and “I” cells, to fix the temperature of the mixture cells, and to estimate the mass transfer.

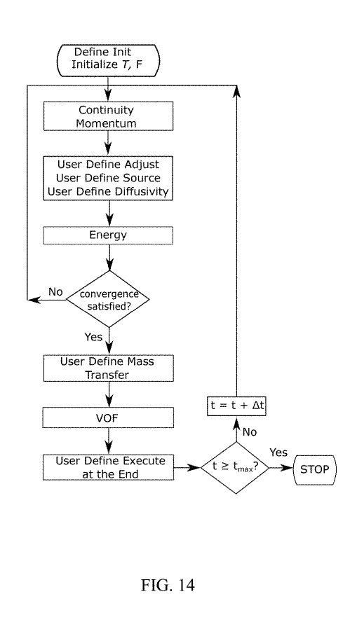

FIG. 14 shows a flow diagram of the procedures in the simulation. A UDF set the initial conditions of volume-fraction and temperature field. The UDF Define-Adjust was used to identify the mixture and I cells, and to calculate the energy source terms with Eq. (13). The UDF Define-Source declared the source terms in the energy equation Eq. (8). The UDF Define-Diffusivity adjusts the thermal diffusivity with Eq. (9). The mass transfer was computed with Eq. (3) in the UDF Define-Adjust, and it was declared in the VOF equation with the UDF Define-Mass-Transfer. The UDF Execute-at-the-End cleaned the variables, including the User-Defined-Memories that passed information between UDFs.

To identify the mixture and I cells an algorithm that connects the two cells that share a face was developed. The identification algorithm makes a loop through all the faces of the cells in the computational domain, and uses connectivity macros to retrieve the volume-fraction of the two cells connected with a face. A cell is defined as a mixture cell if its liquid volume-fraction is greater than zero and is next to a vapor cell with a liquid volume-fraction of zero. The “I” cells were identified with connectivity macros and the mixture cell. A cell is a neighboring cell if it lies next to a mixture cell and has liquid volume-fraction greater than zero. A loop over the four faces of the neighboring cell identifies the I cell based on the coordinates of the reference point (see FIG. 3) and the coordinates of the cells around the neighboring cell.

In ANSYS-Fluent, the large coefficients method fixes the temperature of the mixture cells. Patankar proposed this method to fix the temperature of internal cells in the computational domain. Sun et al. used the large coefficients method to fix a saturation temperature at the mixture cells in ANSYS-Fluent. In the present invention, the method fixes T₁ at the mixture cells. The source term in the energy equation is defined as:

S_{T}=CT_{ic}−CT_{i,j} At the mixture cell i,j

S_{T}=0At other cells(13)

where C is a large coefficient 10³⁰, and T₁₁ is the temperature of the mixture cell provided by the solution of ANSYS-Fluent. The main advantage of the large coefficients method is that it is independent of the software procedures. This is important because in ANSYS-Fluent the source codes that solve the governing equations are unavailable. Therefore, the correction of the software procedures at the neighboring cells is not trivial.

Another important fact is that the simulation ignores the energy equation used by ANSYS-Fluent. Instead, we adopted a User-Defined-Scalar (UDS) equation, which is a general transport equation. The main advantage of a UDS is that it provides access to the customization of the transient, the convective, and the diffusive terms.

Theoretical Models for Validation.

In the simulation of interfacial heat and mass transfer, the validation is necessary to ascertain that the mass transfer and the interface effects are properly captured by the numerical model. Techniques to validate a phase-change simulation include theoretical models for temperature and interface displacements, and experimental bubble shape or heat transfer data. Both approaches are generally accepted, but the theoretical models account for most of the physics in the phase change process and at the same time provide a unique solution. Therefore, theoretical models are commonly used for the validation of boiling simulations.

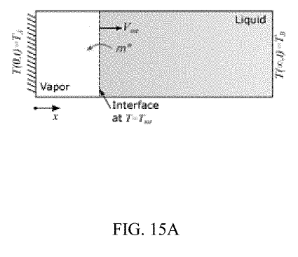

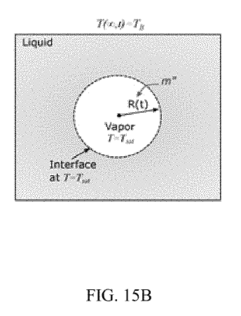

The theoretical models for validation are Stefan problems for a planar interface and spherical bubble growth, see FIG. 15. Stefan problems test the accuracy of the mass transfer computation and the inclusion of the interface effects in a simplified environment such as one-dimensional heat flow. Spherical bubble growth tests the accuracy of the phase change phenomena in an environment with curved interfaces. The following subsections describe the theoretical framework of these problems.

Planar Interface Evaporation.

Various works have simulated Stefan problems to validate simulations of phase change. Son and Dhir numerically analyzed the transition of bubble patterns in film boiling near critical pressures. Errors in interface displacement of Stefan problems with a saturated liquid and a superheated vapor were significant at the beginning of the simulation (from 0 to 0.1 s), but they decreased to 2% at longer times. Kunkelmann and Stephan simulated pool boiling of HFE-7100. Minimal differences were observed between theory and the simulation of saturated vapor and superheated liquid. In a previous work, we simulated Stefan problems with heat transfer in both phases and with large density ratios, Perez-Raya and Kandlikar. Simulations and theory showed good agreement in terms of interface displacement and temperature distribution.

A schematic diagram of planar interface evaporation is shown in FIG. 15A. In this problem heat flows only in the x-direction. A wall and the interface constrain the vapor, and the liquid is unconstrained. The mass transfer is from liquid to vapor. During phase change, the vapor expands because the vapor has a lower density relative to the liquid. The vapor expansion induces motion in the liquid, which results in a convective transport. The boundary conditions are T=T_{A} at x=0, T=T_{B} at x=00, and a moving interface with T=Tₛₐₜ.

The 1D heat diffusion equation governs the heat transfer in the vapor, whereas the 1D advection-diffusion equation governs the heat transfer in the liquid. The mass transfer at the interface depends on the heat flux on both sides of the interface. In a previous work we provided a detailed description of planar interface evaporation including discretization schemes and ANSYS-Fluent customization, Perez-Raya and Kandlikar. The theoretical solutions for the interface position X(t) and the temperature distribution T(x,t) on the phases are given by Eqs. (14)-(17).

$$\begin{matrix} X ( t ) = ξ \sqrt{t} & ( 14 ) \\ T ( x , t ) = {T}_{A} - ( {T}_{A} - {T}_{sat} ) \frac{erf ( \frac{x}{2 \sqrt{{α}_{v} t}} )}{erf ( \frac{ξ}{2 \sqrt{{α}_{v}}} )} 0 \leq x \leq X ( t ) & ( 15 ) \\ T ( x , t ) = {T}_{B} - ( {T}_{B} - {T}_{sat} ) \frac{erfc ( \frac{x}{2 \sqrt{{α}_{l} t}} - \frac{ξ}{2 \sqrt{{α}_{l}}} ( 1 - φ ) )}{erfc ( \frac{ξ}{2 \sqrt{{α}_{l}}} φ )} X ( t ) \leq x \leq ∞ & ( 16 ) \\ \frac{ξ \sqrt{π}}{2} {h}_{fg} = \frac{\sqrt{{α}_{v}} {c}_{v} ( {T}_{A} - {T}_{sat} )}{exp ( \frac{{ξ}^{2}}{4 {α}_{v}} ) erf ( \frac{ξ}{2 \sqrt{{α}_{v}}} )} + \frac{\sqrt{{α}_{L}} {c}_{l} ( {T}_{B} - {T}_{sat} )}{φexp ( \frac{{ξ}^{2}}{4 {α}_{l}} {φ}^{2} ) erfc ( \frac{ξ}{2 \sqrt{{α}_{l}}} φ )} & ( 17 )\end{matrix}$$

In Eqs. (14)-(17), ϕ is the density ratio ρᵥ/ρₗ, cₗ and cᵥ are specific heats, and ξ is a constant determined with Eq. (17). Eq. (15) provides the vapor temperature distribution, whereas Eq. (16) provides the liquid temperature distribution. It is important to emphasize that previous numerical works on planar interface evaporation have used semi-analytical solutions in cases where the liquid is superheated. However, Eq. (14)-(17) represent exact solutions that apply for all possible cases including a superheated liquid.

Spherical Bubble Growth.

Spherical bubble growth tests the numerical parameters related to the interface curvature. These parameters include surface tension, normal vector, interface area, and mass transfer. A schematic diagram spherical bubble growth is shown in FIG. 15B.

The technical literature distinguishes two cases of spherical bubble growth. The first case is an adiabatic bubble where the mass flux is prescribed independently of the liquid temperature. The simulation of adiabatic bubble evaluates errors on mass conservation and momentum transport. The second case is a non-adiabatic bubble growth where the mass flux is prescribed with the heat flux at the interface. The non-adiabatic problem quantifies errors on the computation of the mass transfer and on the solution of the energy equation with a moving curved interface.

The simulation of adiabatic bubble growth ascertains the proper computation of the interface curvature and surface tension. Tanguy et al. simulated the evaporation of a two-dimensional drop with a prescribed mass flux. Jump conditions were used to include interface effects in the Navier-Stokes equations. A projection method extended the liquid velocities into the gaseous phase and vice versa. The velocity fields were extended with a ghost pressure. Results showed that the computed temporal mass variation of the vaporizing drop and the exact solution were the same in a 1 ms interval. In a different work, Tanguy et al. simulated adiabatic spherical bubble growth with a constant mass flux to compare whole domain and jump continuous formulations. The whole domain formulation smeared the interface across 2 or 3 computational cells, and the jump continuous formulation adopted ghost cells for the velocity. The simulation had a 2D axisymmetric domain with an initial bubble radius of 1 mm. Relative to the exact solution of the bubble radius, the whole domain formulation had a 25% of error, and a continuous jump had less than 1% of error. The authors concluded that average velocities at the interface in the whole domain formulation and spurious currents lead to wrong interface displacements.

Non-adiabatic spherical bubble quantifies errors on the mass transfer and on the interface effects. Son simulated spherical bubble growth with the level-set method. A volume correction step ensured mass conservation. The computed bubble maintained a spherical shape and the growth rate was equivalent to the theory. Tanguy et al. simulated spherical bubble growth, the simulation accurately predicted growth rates with both a simple and a divergence-free velocity extrapolation. Relative to the linear extrapolation, a quadratic extrapolation of the thermal field improved the accuracy. Sato and Niceno simulated a spherical bubble; the accuracy of the simulation improved with smaller cells (grid cell sizes of 1 μm or less). There are other works that have simulated non-adiabatic spherical bubble growth.

The theoretical expression for the radius of a non-adiabatic bubble as a function of time is given by Eq. (18).

$$R ( t ) = {R}_{0} + \frac{{m}^{″}}{{ρ}_{v}} t \qquad ( 18 )$$

where R₀ is the initial bubble radius, and m″ is the mass flux. The theoretical expression is easily derived with a mass balance at the interface.

Scriven theoretically analyzed spherical bubble growth in uniformly superheated liquid. The theory is based on the solution of the advection-diffusion equation in spherical coordinates. The solution uses a similarity variable. One important assumption is that the saturation temperature remains constant during the bubble growth. Also, the mass flux depends on the heat flux at the interface. The solution assumes that the bubble radius is given by Eq. (19).

R(t)=2β\sqrt{αₗt} (19)

Eq. (20) gives the temperature distribution in the liquid side.

$$T ( r , t ) = {T}_{B} - ( {T}_{B} - {T}_{sat} ) \frac{{\int }_{s}^{∞} {λ}^{- 2} exp ( - {λ}^{2} - 2 {ɛβ}^{3} {λ}^{- 1} ) d λ}{{\int }_{β}^{∞} {λ}^{- 2} exp ( - {λ}^{2} - 2 {ɛβ}^{3} {λ}^{- 1} ) d λ} \qquad ( 20 )$$

The vapor phase remains at Tₛₐₜ during the bubble growth. In Eq. (20) T_{B} is the liquid temperature at x=∞, ε=1−ρ_{g}/ρₗ, λ is a symbolic variable, and s is the similarity variable defined as:

$$s = \frac{r}{2 \sqrt{{α}_{l} t}} \qquad ( 21 )$$

β is a growth rate constant obtained by solving Eq. (22).

$$2 {β}^{3} [ {h}_{fg} + ( {T}_{B} - {T}_{sat} ) ( {c}_{l} - {c}_{g} ) ] {\int }_{β}^{∞} {λ}^{- 2} exp ( - {λ}^{2} - 2 {ɛβ}^{3} {λ}^{- 1} ) d λ = \frac{{c}_{l} ( {T}_{B} - {T}_{sat} ) {ρ}_{l} / {ρ}_{g}}{exp ( {λ}^{2} + 2 {ɛβ}^{2} )} \qquad ( 22 )$$

It is important to highlight that Eqs. (19)-(22) are equivalent to Scriven's solution. The only difference is that Eqs. (19)-(22) ignore dimensionless parameters and where rearranged to get more discernible expressions.

Results and Discussion.

This section presents results of the simulation of planar interface and spherical bubble growth. The fluid properties correspond to water at 1 atm. The vapor remained at a saturated state and the liquid was superheated. The operating conditions had a superheat level T_{B}−Tₛₐₜ=5 K.

In the simulation, the continuity and momentum equation were solved with the SIMPLE algorithm. The PRESTO (PREssure STaggering Option) scheme interpolated the pressure values at the faces in the momentum equation. The 2^{nd} order upwind scheme discretized the convective terms in the momentum equation. The Power-Law scheme discretized the convective terms in the energy equation. For the diffusive terms in the momentum and energy equation, a central difference second order discretization scheme was adopted. The VOF equation was solved with an explicit scheme with a sharp-type interface modeling without interfacial anti-diffusion. The convergence criteria for the continuity, momentum, and energy equation was set to 1×10⁻⁷. For more details on the discretization schemes, reader is directed to ANSYS-Fluent documentation.

Planar Interface Evaporation.

The initial interface position is X=X₀ that corresponds to a time of t₀=0.1 ms. The initialization at t₀ creates a thick thermal film, which can be captured with large grid cell sizes. The thickness of the thermal film at t₀ is δₜₕ=0.8 mm. Previous numerical works adopted a similar initialization. Eq. (16) determined the initial temperature T(x, 0). The computational domain was one cell thick, which facilitates the access to the mixture and neighboring cells. The time step was 5×10⁻⁶ s, with a Courant number smaller than 0.1.

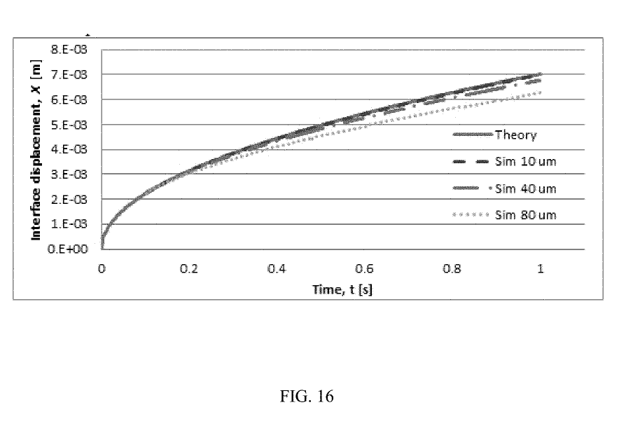

FIG. 16 shows the change in the interface position as a function of time. Grid cell sizes of Δx=80, 40 and 10 μm were adopted. Eq. (14) gives the theoretical interface displacement. The results in FIG. 16 indicate that a reduction in the grid cell size improves the accuracy of the simulation. At 1 s the relative error in interface displacement is 10, 3.5, and 0.04% with 80, 40 and 10 μm, respectively. The good agreement between the theory and the simulation validates the present numerical practices that compute the mass flux and the mixture cell temperature in the evaporation of a planar interface.

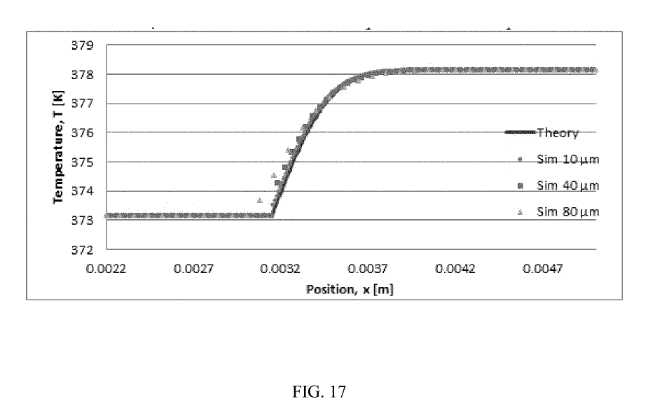

FIG. 17 shows the temperature distribution on the vapor and liquid phases at 0.2 s in the evaporation of a planar interface. At 0.2 s the interface location is X=3.1 mm and the thickness of the thermal film is δₜₕ=1.12 mm. The results in FIG. 17 indicate that the temperature profile gets closer to the theoretical data as the grid cell size Δs is reduced. The number of cells that capture the thermal film is 14 with a cell size of 80 μm and 112 with a cell size of 10 μm. The results indicate that the increase in the grid resolution improves the accuracy of temperature gradient at the interface, which is translated into more precise interface displacements.

Spherical Bubble Growth.

Spherical bubble growth is a more complex simulation that involves the interface curvature, surface tension, and geometrical calculations in the mass transfer. The simulation of a spherical bubble has been adopted by various authors to find anomalies in the numerical practice for interfacial heat and mass transfer.

The simulations with a spherical bubble were performed with an initial radius R₀=0.1 mm. The initial bubble patch had the reconstructed interface, meaning that the initial volume-fractions of the mixture cells correspond to the actual interface location and orientation. The computational domain was a square of length L=0.5 mm. The boundary conditions were axisymmetric at the bottom boundary, symmetric at the vertical boundary in contact with the bubble, and pressure outlet at the other boundaries. Only one quarter of the domain is simulated with axisymmetric and symmetric boundary conditions.

The following subsections analyze the normal vector, temperature gradient, and mixture cell temperature. These parameters are primary factors that influence the accuracy of the simulation. Also, a subsection is dedicated to analyze the fluid and thermal behavior during bubble growth.

Computation of the Normal Vector.

The normal vector is applied in the interface reconstruction algorithm, the surface tension model, the interface surface area estimation, and the computation of temperature gradient. Thus, it is convenient to analyze the exactitude of the numerical model in determining the normal vector.

The analysis compares the numerical and the theoretical normal vector at the initial conditions. Eq. (7) gives the numerical normal vector with the gradient of volume-fraction. The gradient of volume-fraction is a Green-Gauss node-based gradient, which finds the gradient at the cell center based on the Green-Gauss Theorem with reconstructed values at the nodes. The gradient of the function that represents the circumference provides the theoretical normal vector.

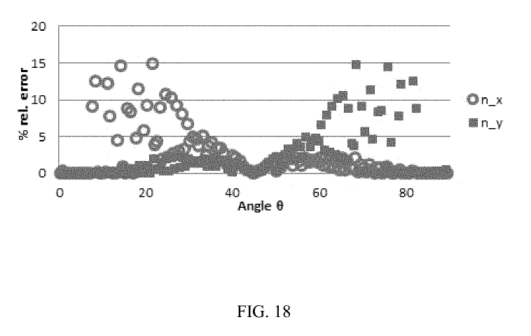

FIG. 18 shows the accuracy of the numerical solver in the estimation of the normal vector. The percentage of relative error is given by (nₜₕ−nₛᵢₘ)/nₜₕ×100. The angle θ is measured from the vertical boundary in the clockwise direction. The results in FIG. 18 show a symmetrical plane at θ=45°. The relative error in n_{y} is less than 3% when θ is smaller than 45°, but it can be as high as 16% when θ is greater than 45°. The relative error in nₓ shows a similar trend along the opposite direction. The average relative error of 2.21% indicates that the number of cells with an inaccurate estimation of the normal vector is low. We observed that the relative error is high when the cell is almost fully saturated with vapor or with liquid (cells that have Fₗ or Fᵥ larger than 0.95). It is important to notice that the errors are larger when the magnitude of the normal vector is small. For instance, at =18° nₓ=0.25, n_{y}=0.97, the relative error in nₓ and n_{y} is 14.52 and 0.86%, respectively. Consequently, the net effect of the large errors in the estimation of the components of the normal error may not be significant.

The adiabatic bubble growth considers a constant mass flux at the interface. The simulation provides information on the solution of the momentum and VOF equations. Previous works have reported the presence of parasitic velocities that arise mainly due to errors in the estimation of the normal vector. Parasitic velocities create convective currents that might affect the momentum and energy transport near the interface. To determine the magnitude of the parasitic velocities in the simulation, the velocity field near the interface was analyzed. The study identified the mixture and I cells after the first time-step. The mixture and I cells were identified with the algorithm described in Section 2.3. The velocity magnitude of the I cells was retrieved and compared with the theoretical liquid velocities. The imposed mass flux is an average value of the mass fluxes in a non-adiabatic spherical bubble with a 5 K superheated level in a time interval of 1 ms. The corresponding mass flux is m″=0.18 kg/s−m².

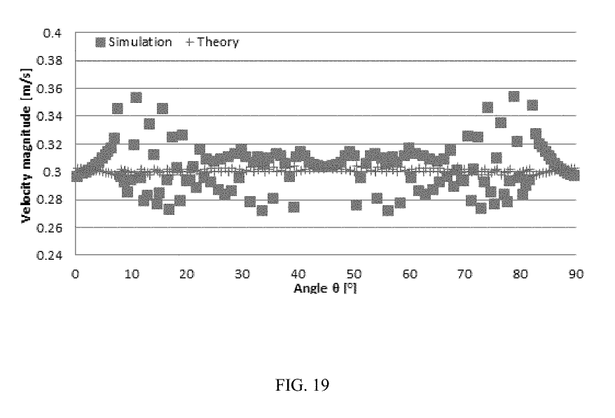

FIG. 19 compares the numerical and theoretical liquid velocities at the I cell. The grid cell size is 1 μm. The results indicate that the predicted numerical liquid velocities are approximately equal to the theoretical values. In general, the numerical and theoretical velocities have the same order of magnitude, which implies that the net magnitude of the parasitic velocity is small. Maximum deviations occur around 15° and 75°, which coincides with the regions of maximum relative errors in the estimation of the normal vector. Therefore, the deviations in the liquid velocity are related to errors in the estimation of the normal vector. It is important to notice that the deviations oscillate around the corresponding theoretical value, which might contribute to alleviate the errors in the net convective transport.

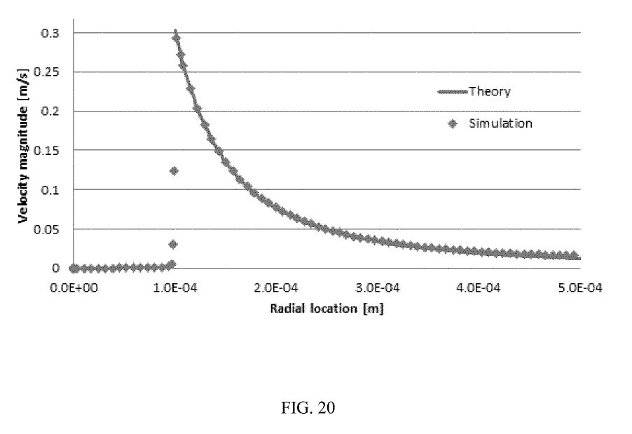

FIG. 20 compares the numerical and theoretical velocities along the radial direction at θ=0°. The results show evidence of an accurate fluid velocity distribution. In theory, the fluid velocity should change from zero to a maximum value at the interface. Conversely, the simulation has a continuous change in the vapor velocity near the interface. In the liquid phase, the velocity magnitude decreases in the radial direction and is maximum near the interface. The continuous change in the vapor velocity near the interface is due to the use of average properties at the mixture cell in the solution of the momentum equation. A more accurate simulation should consider ghost velocities at the mixture cells as proposed by Tanguy et al. However, the use of average properties affects the velocity of just two vapor cells around the interface, which still provides a reasonable approximation of the bubble growth process.

The effect of the continuous jump in velocity in the bubble growth can be assessed by a straight comparison between the numerical and the theoretical bubble radius. To develop this analysis, a simulation with a constant mass flux was run for 1 ms, and the numerical vapor volume was reported at different times. The vapor volume provided the numerical bubble radius under the assumption of a spherical bubble, and Eq. (18) determined the theoretical bubble radius.

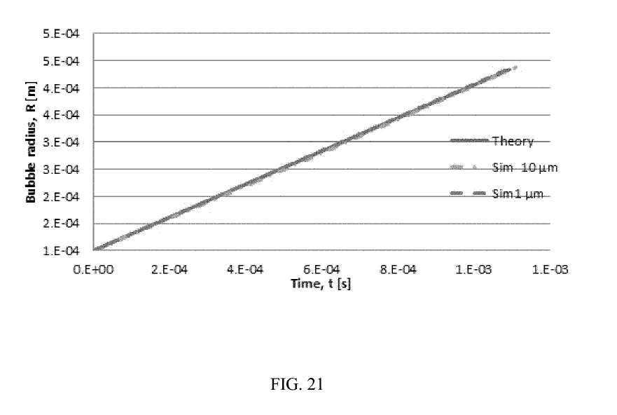

FIG. 21 compares the numerical and the theoretical bubble radius. The simulation considered two different grids cell sizes of 10 and 1 μm. The results show excellent agreement between the numerical and the theoretical bubble radius as a function of time. Also, it is observed that both grid cell sizes provide a similar level of accuracy. The good agreement is mainly due to the fact that the VOF method is mass conservative. In other words, the VOF method moves the interface with a change in volume rather than by keeping track of the interface velocity. Other relevant aspect is that the continuous change in the vapor velocity (see FIG. 20) has a minor effect in the interface displacement. This implies that the advection of the interface with the VOF equation is mainly influenced by the source term rather than by the vapor velocity. Moreover, the good agreement proves the correctness of the mass source term declaration in the VOF equation, including the identification of the mixture cells and the estimation of the interface surface area.

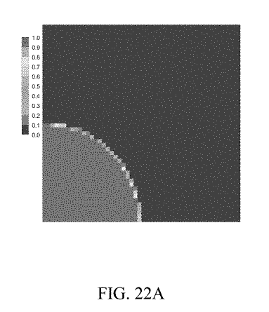

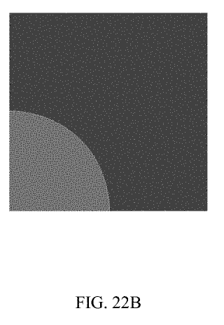

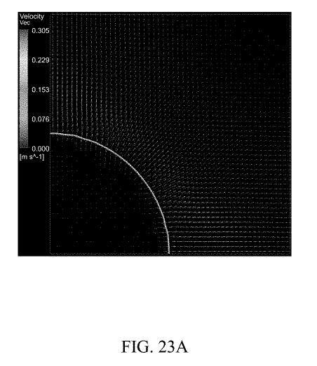

FIG. 22 shows the vapor volume-fractions Fᵥ at 0.5 ms for the grid cell sizes of 10 and 1 μm. The vapor and liquid phases have Fᵥ equal to 1 and 0, respectively. The mixture cells (cells with an interface) have vapor volume-fractions in the range of 0 to 1. The contours of volume-fraction indicate that the bubble shape is maintained during the simulation. Also, the grid cell size significantly changes the interface resolution; a grid cell size of 1 μm creates an almost unperceived division between the liquid and the vapor phases. The results in FIG. 22A clearly show that the interface lies within one cell. It is important to emphasize that the interface was not smeared, and the mass source terms were not distributed into two to three cells as it has been previously done by several works. The distribution of the mass source terms is usually done to preserve the stability of the simulation. However, the results in the present work indicate that the numerical simulation remains stable with mass source terms only at the mixture cells and with a sharp interface. The numerical methods in the present work provide a more accurate representation of the fluid behavior near the interface.

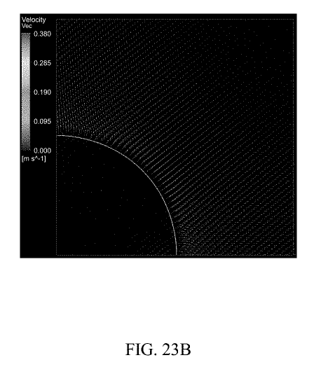

The velocity vectors at 0.5 ms are shown in FIG. 23. The vapor velocity is small because the bubble remains static during the phase-change. The liquid velocity is highest at the interface and it decreases as the fluid gets far from the interface due to the increase in the fluid area. At the interface, the liquid velocity is high due to the expansion of the vapor during phase change. For a certain volume of liquid consumed Vₗ, the equivalent volume of vapor generated Vᵥ is almost 1600 times higher (ρₗVₗ=ρᵥVᵥ). Therefore, during the phase change process, the vapor expansion increases the momentum of the surrounding liquid. The velocity vectors in FIG. 23 indicate that the grid cell size affects the velocity jump at the interface. The continuous change in velocity is less notorious as the grid cell size is reduced. However, as it was previously mentioned, the change in velocity at the interface has a minimal influence in the simulation since the interface displacement is mainly governed by the mass transfer.

Non-Adiabatic Bubble Growth.

Non-adiabatic bubble growth considers heat transfer in the liquid. In this problem, the mass transfer depends on the temperature gradient at the interface. This problem measures the effect of errors in the estimation of the normal vector and parasitic velocities in the energy transport. Relative to adiabatic bubble growth, the simulation of non-adiabatic bubble growth is more challenging since errors in the temperature near the interface directly affect the mass transfer. These errors could arise due to incorrect numerical practices in the mixture and neighboring cells.

The initial conditions in the simulations of a non-adiabatic spherical bubble are the same as in adiabatic bubble growth. Eq. (20) provided the initial temperature distribution at R₀=0.1 mm. In non-adiabatic spherical bubble growth, the mass transfer is driven by a thin thermal layer in the liquid side next to the interface. The initial thickness of the thermal layer is δₜₕ=12 μm. Therefore, small grid cell sizes are needed to properly capture the thermal layer. The time step in the simulation was 10⁻⁸ s.

Temperature Gradient.

In the simulation of bubble growth, the mass transfer model uses the temperature gradient at the interface, see Eq. (3). To determine the temperature gradient, the present work proposes a method that requires the identification of only one cell. The one-cell method facilitates the computation of the heat flux at the interface, and it can be easily implemented in a numerical solver.

A comparison between the numerical and the theoretical temperature gradient provides evidence of the accuracy of the simulation in the computation of the temperature gradient. To perform this task, the one-cell method computed the numerical temperature gradient with Eqs. (10)-(11), and Scriven's solution estimated the theoretical temperature gradient with Eq. (20). The evaluation was done with the initial conditions and with a grid cell size of 1 μm.

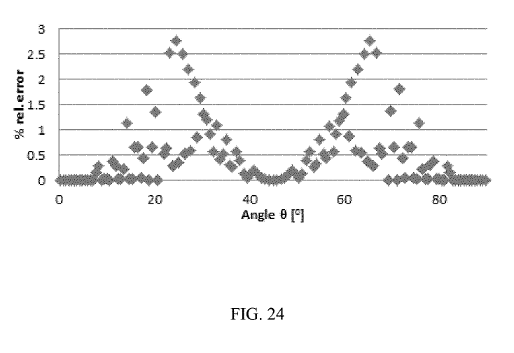

The relative error between the computed and the theoretical values is shown in FIG. 24. The results include all the I cells around the interface. The results show that the maximum relative error is about 2.7%, which is small and might not really affect the estimation of the mass transfer. The symmetry at θ=45° indicates that the present method is independent of the interface orientation. A comparison between FIGS. 24 and 18 shows similar trends in the temperature gradient and normal vector along the interface. This implies that the variations in the estimation of the temperature gradient are related to errors in the estimation of the normal vector. The normal vector influences the estimation of the temperature gradient because the distance between the I-cell center and the interface is calculated with the normal vector, see Eq. (10). However, it is important to notice that the large relative errors in the normal vector have a minimal effect on the estimation of the temperature gradient. For instance, the maximum 16% error in the normal components leads to a 3% error in the estimation of the temperature gradient. Other important fact is that the present method is independent of the interface tracking algorithm, and that other interface tracking methods with a better estimation of the normal vector could reduce the error in the computation of the temperature gradient.

Table 5 shows the average relative error on the estimation of the temperature gradient for grid cell sizes of 1, 0.8 and 0.6 μm. The average errors are less than 0.42%, which might provide a reasonable approximation to the phase-change process. Also, the results indicate that the maximum and average relative error are insignificantly influenced by the grid cell size, which proves that the one-cell method maintains its accuracy with smaller grid cells.

TABLE 5
Dependence of the relative error with the grid cell size.

| Grid cell size (μm) | Max | Average |
|---|---|---|
| 1 | 2.7 | 0.38 |
| 0.8 | 3.3 | 0.41 |
| 0.6 | 3.1 | 0.39 |

Temperature of the Mixture Cells.

The interface effects in the solution of the energy equation are included by fixing the temperature of the mixture cells. In the simulation, Eq. (12) determines the fixed or imposed mixture cell temperature based on the temperature gradient at the interface.

To assess the validity of Eq. (12), we compared the theoretical mixture temperature with the computed interface cell temperature. The procedure required the identification of the mixture and I cells, and the estimation of the temperature gradient with Eqs. (10)-(11). Scriven's solution Eq. (20) determined the theoretical mixture cell temperature. Scriven's solution is valid only for the liquid side, but Eq. (20) has a continuous temperature variation through the interface. Therefore, the theoretical temperature can provide mixture temperatures while keeping a uniform temperature gradient through the interface. The procedure to find the theoretical mixture cell temperature included the identification of the mixture cells. Next, Eq. (20) determined the theoretical mixture cell temperature with the coordinates of the mixture cells.

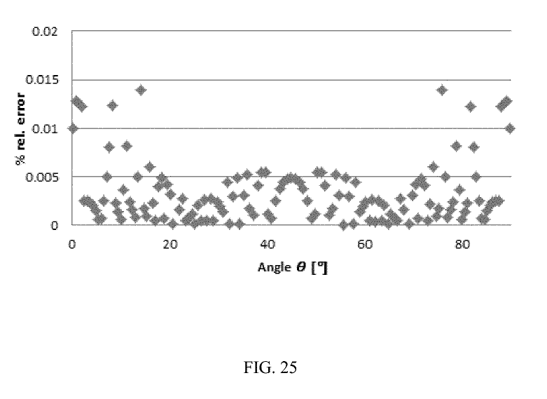

The relative error of the mixture temperature along the interface is shown in FIG. 25. The results indicate that numerical and theoretical values differ in less than 0.015%. The average relative error is 0.007%. The effect of the normal vector becomes less prominent because the temperature gradients in Eq. (12) are calculated approximately at the same location and very close to the interface. The results show that the present method accurately predicts the mixture cell temperature by evaluating the temperature gradient at the interface with two different cell temperatures (the mixture cell temperature and the I cell temperature).

Fluid and Thermal Behavior.

The simulation of a non-adiabatic bubble was performed for a time of 0.1 ms. The initial bubble radius was R₀=0.1 mm. The wall superheat is 5 K and the properties correspond to water at 1 atm. Similar times of simulation and initial conditions were adopted in previous numerical works of bubble growth. The initial temperature field was obtained with Eq. (20), the temperature of the cells were imported into the software with the UDF Init. The objective is to evaluate if the developed methods correctly simulate the phase change process. These methods include: (i) estimation of the mass transfer, (ii) estimation of the interface cell temperatures, and (iii) numerical solver customization.

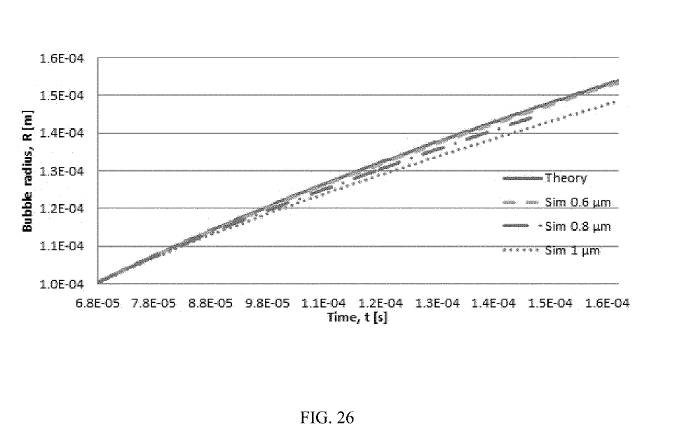

The numerical and theoretical bubble radius were compared to evaluate the accuracy of the simulation. The numerical bubble radius was calculated with the vapor volume by assuming a spherical bubble. The theoretical bubble radius was calculated with Scriven's solution Eq. (19). FIG. 26 compares the computed and the theoretical bubble radius. The computational domain had grid cell sizes of 1, 0.8 and 0.6 μm. The results indicate that the computed bubble radius agrees with Scriven's solution and that the accuracy of the simulation improves as the grid cell size is reduced. The relative error at 1.18 ms is 2.24, 0.83, and 0.24% with grid cell sizes of 1, 0.8, and 0.6 μm. The improvement is due to the higher grid resolution in the thermal film obtained with smaller grid cells. The number of cells in the thermal film at the beginning of the simulation is 12, 15, and 20 for grid cell sizes of 1, 0.8, and 0.6 μm, respectively. The agreement between the theory and the simulation proves two important aspects of the simulation: (i) the validity of Eq. (11) and (12) to find the temperature gradients and the mixture cell temperatures, and (ii) the proper customization of the software ANSYS-FLUENT to conduct simulations of heat and mass transfer with a heat flux at the interface.

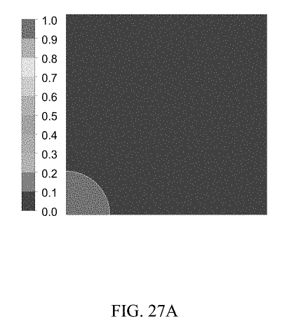

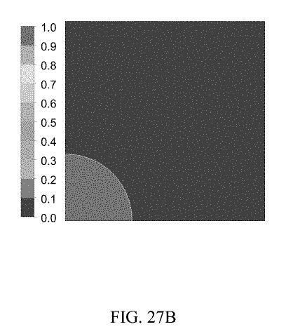

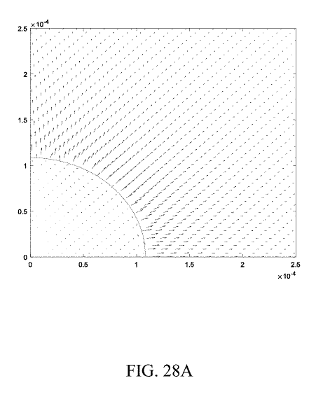

The variation of the temperature gradients along the interface provides a non-uniform mass transfer. Also, the mass source terms were not redistributed, which implies that the simulation contains a peak in the mass source terms at the mixture cells. Moreover, the interface was not smeared, which provides an abrupt change in the thermal properties at the interface. These factors might introduce interface deformations or numerical instabilities as pointed out by previous works. To observe possible deformations of the interface, the bubble shape was analyzed at different times. FIG. 27 shows the vapor volume fraction at 0.08 (FIG. 27A) and 0.12 ms (FIG. 27B). The results indicate that the bubble shape is conserved throughout the simulation. The interface shape is maintained despite the 3% in variation in mass transfer and the peak in mass transfer at the mixture cell. Also, the numerical solution was stable; the residuals for the continuity and momentum equations reached the convergence criteria with a similar trend as with a constant mass flux, and the energy equation converged in less than five iterations.

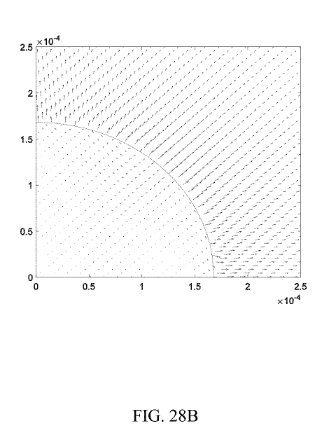

The variation of the mass flux in space and in time might generate parasitic currents around the interface. To investigate this fact, FIGS. 28A and 28B show the velocity vectors around the interface at two different times in the non-adiabatic bubble growth. The data generated by the numerical solver was exported into graphics software to provide a better visualization of the flow behavior. The velocity vectors indicate that in the liquid the flow is uniform with no appreciable circulatory flows. As the bubble grows the vapor velocity near the interface seems to increase, but the magnitude is much smaller than the interface velocity. These results indicate that the presence of parasitic currents is not a primary factor affecting the accuracy of the simulation. This is mainly due to the vapor expansion, which increases the velocity of the liquid cells. The increase in the liquid velocity during the phase change process suppresses any detrimental surface tension effects at the interface.

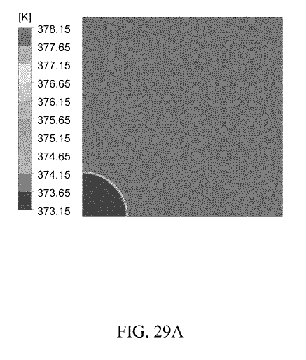

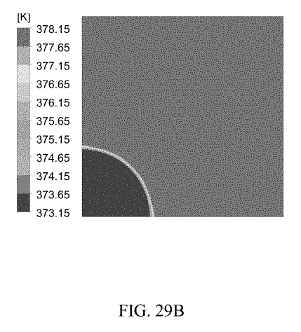

Proper temperature distributions around the interface require of special numerical practices at the mixture and neighboring cells. Errors in the temperature field directly affect the bubble growth rate and the heat transfer mechanisms near the interface. Contours of temperature in a non-adiabatic bubble growth provide direct evidence of the thermal behavior around the interface. FIG. 29 shows the temperature fields at 0.08 (FIG. 29A) and 0.12 ms (FIG. 29B). The results indicate that the simulation provides uniform temperature distribution around the interface. These results imply that the interface is correctly considered as a moving boundary in the solution of the energy equation. Other import fact is that the thermal film remains thin during the bubble growth process. The thermal film is not consumed during the bubble growth process, but it moves along with the surface due to the convective transport. At the same time, the thickness of the thermal film increases with time due to the diffusive transport. The results in FIG. 29(b) show a slight increment of the thermal boundary layer near the domain boundaries. A similar trend was also observed by Sato and Niceno. This behavior might be due to the presence of slightly higher velocities near the boundaries. Nevertheless, the adopted approach provides a reasonable prediction of the thermal behavior around the interface during bubble growth.

To our knowledge, only the work of Sato and Niceno has reported the temperature distribution around the interface in spherical bubble growth. However, Sato and Niceno used a method to calculate the mass transfer with the temperature gradient at the neighboring cell center. The authors also developed an in-house code to develop the simulation. Therefore, the present work might be the first numerical work that has shown proper temperature distributions at the interface in the simulation of spherical bubble growth while using a numerical software. This was possible by proposing methods that simplify the numerical practices needed to accurately capture the interfacial heat and mass transfer processes in bubble growth.

### CONCLUSIONS

The present work described an alternative approach to compute the mass transfer and the temperature of the cells that have an interface in the simulation of bubble growth. Moreover, the work revealed the customization of ANSYS-Fluent to account for interfacial heat and mass transfer.

Previous numerical simulations of interfacial heat and mass transfer estimated the heat flux at the interface with methods that require the identification of multiple cells around the interface. The identification of multiple cells inhibits the use of these methods in simulation packages. As a result, simulations in commercial solvers have adopted various assumptions or alternative methods to compute the mass flux. The present work proposed a one-cell method to find the heat flux at the interface. The main advantage is that the one-cell method uses only one cell, which reduces the complexity of computing the mass flux at the interface.

To account for the sharp interface, the temperature of the cells that have an interface was fixed. A mathematical expression was proposed to compute the mixture cells temperature based on the temperature gradient at the interface. The mathematical expression reduced the complexity of finding the mixture cells temperature, since it provides a direct estimation and avoids the use of complex functions. Results indicate that the computed mixture cells temperature was in good agreement with the theoretical values.

The software ANSYS-Fluent was customized to account for the interfacial heat and mass transfer. User Defined Functions (UDFs) calculated the mass transfer, and declared source terms in the continuity and energy equation. Different to previous works, the mass transfer used the temperature gradients at the interface. The high-coefficient method eliminated the software procedures at the mixture cells and fixed a temperature. The adopted procedures maintained a uniform temperature field around the interface and a thin thermal layer.

The present worked proposed methods for the computation of the interfacial heat and mass transfer. It also uncovered the requirements to customize the software ANSYS-Fluent to develop simulations of phase change. Therefore, the present work described an alternative approach that simplifies the analysis of interfacial heat and mass transfer with computer simulations.

### Nomenclature

Aᵢ Interface surface area (m²)
D Distance interface to cell center (m)
C Large coefficient
C Specific heat (J/kg-K)

### F Volume-fraction

h_{fg} Latent heat (J/kg)
K Thermal conductivity (W/m-K)

### K Curvature (1/m)

m″ Mass flux (kg/s-m²)
\hat{n} Unit normal vector

### p Pressure(N/m²)

r Radial coordinate (r)
R Bubble radius (m)
S_{M} Momentum source term (N/m³)
S_{T} Energy source term (K/s)
sd Distance interface to cell center (m)

### T Temperature (K)

### t Time (s)

V_{c} Cell Volume (m³)
v Velocity (m/s)
X Interface position (m)
x x-position (m)
α Thermal diffusivity (m²/s)
β Bubble growth constant
μ Dynamic viscosity (Pa-s)
ξ Growth rate constant
ρ Density (kg/m³)
σ Surface tension (N/m)
ϕ Density ratio

### Subscripts

### l Liquid

### sat Saturation

### v Vapor

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. A method for modeling interfaces comprises:
determining a fixed value of a variable ϕ at mixture cells for a representation of an interface; and
determining the mass transfer through the interface with the gradient of ϕ at the interface, wherein the gradient is computed on a phase that is driving the mass transfer, wherein fixing the value of the mixture cells, the gradient is computed on the phase driving the mass transfer, by evaluating the gradient of the variable ϕ by performing an algorithm that identifies the center of cell in the phase that is closest to the interface in the normal direction, the algorithm injecting three proves in a direction perpendicular to the interface, and the fixed value of the variable ϕ and the interfacial mass transport are found with the information of the length of the probes and the values of the variable ϕ at the extremes of the probes, wherein mathematical expressions are derived based on the gradients of the variable ϕ at two different locations at the interface, such that a representation of the conditions at the interface in a multiphase simulation and computation of the mass transfer at the interface are achieved.

2. A one-cell method for evaluating the temperature gradient at the interface, comprising:
1) identifying a mixture cell for which a fixed ϕ value or the mass transfer is to be determined;
2) injecting a probe-1, wherein the origin is the mixture cell center, the orientation is normal to the interface, and the length is such that the tip intersects the interface such that the point intersects the probe-1 with the interface at a point a;
3) injecting a probe-2, wherein the origin is the point a, the orientation is normal to the interface, and the length is d₂;
4) exploring a region around the tip of the probe-2 to find the center of an I-cell that is nearest to the interface in the normal direction;
5) injecting a probe-3, wherein the origin is the cell center of the I-cell, the orientation is normal to the interface, and the length is determined by the following steps 6) and 7);
6) creating a vector \vec{r_{I}} connecting the center of the I-cell with the point a at the interface; and
7) determining the length of the probe-3 by the projection of the vector \vec{r_{I}} on the normal vector n, and determining the intersection point b between the probe-3 and the interface.

3. A method comprising:
injecting three probes that are perpendicular to the interface, wherein probe-1 supports the injection of probe-2, probe-1 and probe-2 support the construction of probe-3 and probe-3 is normal to the interface, and has a length such that the tip of the probe intersects a cell center on a phase;
injecting probe-1 based on the identification of the computational cell that has an interface, wherein the origin of probe-1 is the mixture cell center, the orientation is normal to the interface, and the tip of the probe is the intersection of the probe with the interface, wherein the point that intersects the probe with the interface can be identified as point a, the length of the probe-1 is given by d₁, and the length of the probe is determined based on the origin and the tip of probe-1;
injecting probe-2 based on the tip of the probe-1 point a, wherein the origin of probe-2 is point a, the orientation is normal to the interface, and the length is d₂;
using probe-2 to identify the center of computational cell in a phase that is closest to the interface along the normal direction, wherein the nearest cell can be identified as I-cell;
exploring a region that uses the tip of probe-2 as a reference point to find the center of the I-cell that is nearest to the interface along the normal direction, wherein the center of the explored region corresponds to the location of the tip of probe-2, wherein the dimensions of the explored region are Δx in the x-direction, Δy in the y-direction, and Δz in the z-direction, where x, y, and z represent the coordinates of a Cartesian system and Δx, Δy, and Δz are the lengths of the computational cells in the x, y, and z, directions, respectively;
using the I-cell to inject the probe-3, wherein the origin of the probe-3 is the center of the I-cell, the orientation is normal to the interface, and the length is determined by the projection or dot-product of the vector \vec{r_{I}} on the unit vector that is normal to the interface \hat{n}, wherein (d₃=\vec{r_{I}} ·\hat{n}). \vec{r_{I}} is a vector that connects the center of the I-cell with the point a at the interface;
using the lengths of probe-1 “d₁” and probe “d₃” and the values of the variable ϕ at the extremes of the probes to determine the value ϕ_{M} of the computational cells that have an interface;
determining the fixed value ϕ_{M} by adding the product of the length of the probe-1 “d₁” with the gradient of the variable ϕ at point a to the value of the variable ϕ at the interface, wherein ϕ_{M}=ϕᵢₙ+d₁(ϕ_{I}−ϕᵢₙ)/d₃. ϕᵢₙ is the value of the variable ϕ at the interface and ϕ_{I} is the value of the variable ϕ inside the computational cell-I;
using the lengths of probe-1 “d₁” and probe “d₃” and the values of the variable ϕ at the extremes of the probes to determine the transport of mass or species or any other transport across the interface;
determining the transport of mass or species m″ by the product of a parameter α and the gradient of the variable ϕ at point “a”, m″=α(ϕ_{I}−ϕᵢₙ)/d₃, where a is constant or a variable parameter that depends on the properties of the fluids or phases in the simulation;
estimating the length of the probe-2 based on the dimensions of the mixture-cell, wherein the length of probe-2 d₂ is such that the tip of probe-2 lies outside of the mixture cell; and
identifying the center of the I-cell based on the tip of probe-2 and an explored region, wherein the length of the explored region is given the dimensions of the computational cells (Δx, Δy, and Δz) or by any other parameters.
